(19) United States
(12) Patent Application Publication
(10) Pub. No.: US 2020/0350798 A1
(43) Pub. Date: Nov. 5, 2020

(54) ACTUATOR STATOR

(71) Applicant: GENESIS ROBOTICS AND MOTION TECHNOLOGIES VANADA UKC, Langley (CA)

(72) Inventors: James Brent KLASSEN, Surrey (CA); Christopher ESTERER, Burnaby (CA); Mateusz KOWNACKI, Surrey (CA); Bradley Christoper POPE, Langley (CA)

(73) Assignee: GENESIS ROBOTICS AND MOTION TECHNOLOGIES VANADA UKC, Langley, BC (CA)

(21) Appl. No.: 16/960,901

(22) PCT Filed: Feb. 16, 2018
(86) PCT No.: PCT/CA2018/050182

§ 371 Date: Jul. 9, 2020

Related U.S. Application Data
(60) Provisional application No. 62/618,600, filed on Jan. 17, 2018.

(51) Int. Cl. H02K 3/52; H02K 7/08

(52) U.S. Cl. CPC H02K 3/522; H02K 7/088

(57) ABSTRACT

An actuator for high rotational speed applications using a stator which utilizes laminated features to reduce Eddy current losses in the stator. This construction allows high pole counts while providing the efficiency and high-speed benefits of a laminated construction. Laminated construction is very challenging for a high pole count lightweight motor, but embodiments of the device provide structural strength, and rigidity, as well as other benefits such as low manufacturing cost, high heat dissipation, integrated cooling channels, and light weight construction. Many of these benefits result from the use of a laminate sandwich of non-magnetic, heat conductive material, such as anodized aluminum, as a structural member of the stator.

### TECHNICAL FIELD

Stator for an electric machine

### BACKGROUND

In some previous motor designs, an interdigitated structure has been used for a rotor. Previous designs use an interdigitated rotor structure made of a soft magnetic material, such as steel, to carry flux from Permanent Magnets (PM's) to the airgap. In those designs, the interdigitated structure is used to prevent flux leakage between adjacent rotor posts. In those designs, a large airgap is required between the two interdigitated structures at the end of the fingers on one main component and the space between the fingers on the other component with the opposite facing fingers.

### SUMMARY

In an embodiment, there is disclosed a stator construction that may be light weight, have improved heat dissipation and be low cost to manufacture due to the possibility of using high production processes such as die casting, with high speed operating capability due to the possibility of using laminated material for the stator posts.

In an embodiment there is a device that eliminates the need for a back iron on the stator by using rotors, such as but not limited to permanent magnet rotors, on both sides of a stator. This creates a flux path that connects through the stator from one rotor to the other without the need for a backiron between rotor posts. This allows one or more solid structural members to be used in the structure (housing) to support and position the stator post inserts. The one or more structural members is preferably made of a lightweight and rigid material with low heat flow resistance such as aluminum. Such materials are typically electrically conductive, so the structure includes an interruption or break in the path around each stator post so eddy currents do not form in the aluminum housing around the outside of each post when the electromagnets are commutated resulting in a changing magnetic field. The interdigitation and, preferably, interlocking of the stator structure fingers achieves the structural integrity that is needed to maintain the required airgap, while eliminating the electrical conductivity path around the posts that would create unwanted eddy currents. The aluminum fingers and connecting structure between the fingers may also provide a heat sink and heat flow path from the electrical coils to the exterior of the device. The presence of aluminum fingers between the coils and the magnets in the rotor may allow higher operating temperatures in the coils without demagnetizing the magnets because these aluminum finger sections carry heat away from the airgap to the outside of the actuator where it can be removed by convection or other cooling means. The center plane opening between the aluminum structural member may serve more than one purpose. It may provide for the posts to include a wider section which acts as a positioning feature to ensure that each post is precisely positioned at the airgap. The space between the aluminum components can also be used as an air or liquid flow path to draw heat away from the aluminum and posts as they are heated by the coils during motor operation. The aluminum can be coated or treated with an electrical insulating coating such as formed preferably by hard anodizing the aluminum to create an electrical insulating coating with good heat flow properties.

In an embodiment there is a stator for an electric machine comprising a first structural member having a first set of fingers and a second structural member having a second set of fingers interdigitating with the first set of fingers. The first set of fingers and the second set of fingers define a plurality of slots between the interdigitated fingers. A plurality of posts is positioned in the plurality of slots.

In another embodiment there is a stator for an electric machine comprising a cage defining an enclosure. The cage comprises a first structural member and a second structural member. The cage comprises eddy current breaks at preferably each post. The first and second structural members define a plurality of slots. A plurality of posts is positioned in the plurality of slots.

In yet another embodiment there is a method of constructing a stator for an electric machine. A first structural member is provided comprising a first set of fingers. A second structural member is provided comprising a second set of fingers. The first structural member is secured to the second structural member by interdigitating the first and second set of fingers. The first and second structural members define a plurality of slots between the interdigitated fingers. A plurality of posts is placed through the plurality of slots.

In yet another embodiment there is a stator for an electric machine comprising a structural member defining a plurality of slots. A plurality of posts is inserted through the plurality of slots. The plurality of posts is formed from a plurality of staples placed adjacent to one another.

### BRIEF DESCRIPTION OF FIGURES

Embodiments of a rotary actuator will now be described by way of example, with reference to the figures, in which like reference characters denote like elements, and in which:

FIG. 1 is a top view of an embodiment of a high speed interdigitated axial flux stator.

FIG. 2 is a partial view showing the interdigitated axial flux stator of FIG. 1 with windings and posts removed.

FIG. 3 is perspective view of structural members of the axial stator of FIG. 1.

FIG. 4 is a partial cut-away perspective view of interdigitated structural members of the axial stator of FIG. 1.

FIG. 5 is an embodiment of a cross-section view of an enclosed double-sided stator without a backiron.

FIG. 6 shows an isometric view of an embodiment of a high speed interdigitated backiron-less linear flux stator.

FIG. 7 is top view of the stator of FIG. 6.

FIG. 8 is a partial isometric exploded view of a stator showing an interdigitated linear cage including structural members with fingers and a backiron.

FIG. 9 is a partial isometric exploded view of the configuration of posts and coils of the stator of FIG. 6.

FIG. 10 is a cross-section view of the stator of FIG. 6 showing coils, posts and interdigitated fingers.

FIG. 11 is a cross-section view of the stator of FIG. 6 showing coils, posts and structural members.

FIG. 12 is an isometric exploded view of an enclosed radial flux stator.

FIG. 13 is a close-up isometric cross-section view of a double-sided backiron-less rotor enclosure having one rotor on an inside diameter of the stator and one rotor on an outside diameter of the stator.

FIG. 14 is an isometric cross-section view of a double-sided backiron-less stator with interdigitated fingers.

FIG. 15 is an isometric view of a radial flux stator cage showing interdigitated fingers.

FIG. 16 is an isometric view showing a radial flux stator cage with the two structural members showing the corresponding fingers separated.

FIG. 17 is an isometric view showing a radial flux stator without a backiron or interdigitated fingers.

FIG. 18 is a partial cross-section isometric view showing posts and coils of an interdigitated radial flux stator.

FIG. 19 is a partial isometric view of the interdigitated radial flux stator of FIG. 18 showing tapered surfaces on the fingers.

FIG. 20 is an isometric view of a radial flux motor with cooling fins.

FIG. 21 is an exploded isometric view of a radial flux motor with interdigitated fingers.

FIG. 22 is a cross-section view of a radial flux motor with interdigitated fingers and a double-sided rotor.

FIG. 23 is a cross-section view of a radial flux motor with interdigitated fingers.

FIG. 24 is an isometric view of a piece of ferrous material.

FIG. 25 is an isometric view of a piece of ferrous material bent into a staple shape.

FIG. 26 is an exploded isometric view showing the arrangement of staples and coils in an axial flux stator.

FIG. 27 is an isometric view of an arrangement of staples in a radial flux motor.

FIG. 28 is an exploded isometric view showing the placement of staples in an axial flux motor.

FIG. 29 is a partial cross section isometric view of an axial double-sided flux motor with one rotor removed.

FIG. 30 is an exploded view of the embodiment of FIG. 29 showing simplified coils.

FIG. 31 is a partial isometric view of an axial flux double-sided backiron-less stator showing coils and posts.

FIG. 32 is a partial isometric view of a linear flux double-sided backiron-less stator showing coils and posts.

FIG. 33 is an isometric view of a linear flux stator showing structural members with eddy current cuts.

FIG. 34 is an exploded view of the linear flux stator of FIG. 33.

FIG. 35 is an isometric view of two cylindrical structural members with axially extending fingers in a separated position.

FIG. 36 is an isometric view of the two cylindrical structural members of FIG. 35 in an interdigitated position.

FIG. 37 is an isometric view of a linear flux double-sided stator with interlocking tabs and recesses on interdigitated fingers.

FIG. 38 is a top isometric view of the stator of FIG. 38.

FIG. 39 is an exploded isometric view of the stator of FIG. 38 showing the interdigitated fingers as well as posts and coils.

FIG. 40 is a cross-section view of the stator of FIG. 38 showing the orientation of the interdigitated fingers and posts.

FIG. 41 is an isometric view of a radial flux stator having a plurality of posts.

FIG. 42 is a partial isometric view of fingers and posts of the radial flux stator of FIG. 41.

FIG. 43 is a partial isometric view of the posts and structural members of the radial flux stator of FIG. 41.

FIG. 44 is a partial isometric view of the posts and structural members of a radial flux stator having two interdigitated ceramic insulation rings.

FIG. 45 is a cross-section isometric view of the radial flux stator of FIG. 44.

FIG. 46 is an axial cross-section isometric view of two outer interdigitated ceramic insulation rings.

FIG. 47 is an axial cross-section isometric view of two inner interdigitated ceramic insulation rings.

FIG. 48 is a partial isolated isometric view showing an example of posts and interdigitated fingers having tabs corresponding to recesses in the structural members of a radial flux stator.

FIG. 49 is a more inclusive isolated isometric view of the interdigitated fingers and posts shown in FIG. 48.

FIG. 50 is an isometric view showing interdigitated structural elements of an axial flux stator.

FIG. 51 is a close-up isometric view of the interdigitated fingers having tabs of the axial flux stator in FIG. 50.

FIG. 52 is an isometric view of the axial flux stator in FIG. 50 showing posts and coils.

FIG. 53 is an isometric view of the axial flux stator in FIG. 50 showing a retaining disk.

FIG. 54 is a partial isometric view of the windings and retaining disk of the axial flux stator in FIG. 50.

FIG. 55 is an isometric view of the interdigitated structural elements of the axial flux stator of FIG. 50.

FIG. 56 is a partial isometric view showing the interdigitated structural elements of FIG. 50 in a set position without posts.

FIG. 57 is a partial isometric view showing the interdigitated structural elements of FIG. 50 in a separated position.

FIG. 58 is an exploded isometric view showing the placement of a single post having tabs in an axial flux stator.

FIG. 59 is an isometric view showing the placement of the single post in FIG. 58 in slots in an axial flux stator.

FIG. 60 is an isometric view showing an encapsulated stator with interdigitated tapered fingers.

FIG. 61 is a cutaway section view of the stator in FIG. 60 showing posts and coils.

FIG. 62 is an exploded view of the stator in FIG. 60.

FIG. 63 is a partial cutaway section view of the interdigitated fingers of the stator in FIG. 60.

FIG. 64 is an encapsulated stator having laminated posts with a back iron.

FIG. 65 is a partial section view of the stator in FIG. 64 showing coils and shoulders.

FIG. 66 is an exploded section view of the stator in FIG. 65 showing end cap shoulders.

FIG. 67 shows a close-up partial isometric cutaway view of posts having caps and lamination stacks in the stator in FIG. 64.

### DETAILED DESCRIPTION

Various embodiments of stators are disclosed herein, including those of radial, axial or linear design. Backiron-less stators can be formed using stators that are double-sided for use with two rotors or that have bent inserts for use with a single rotor. The stators may be formed from interdigitated structural members using interlocking fingers or through non-interlocking structural members that together form a cage. The non-interlocking structural members may include eddy current cuts to reduce the formation of eddy currents.

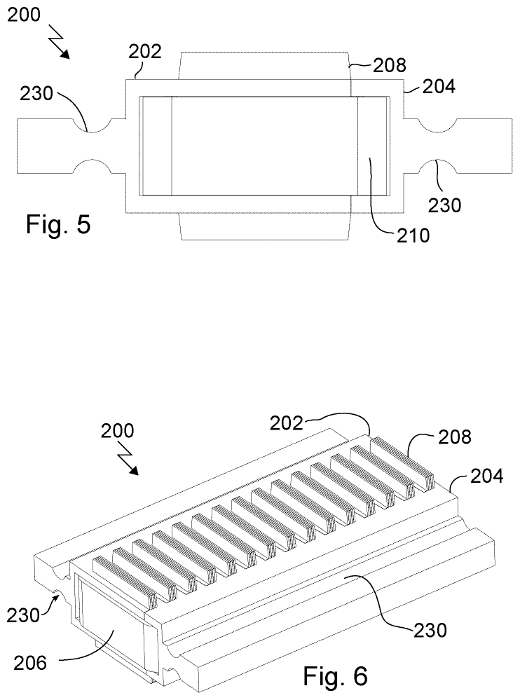

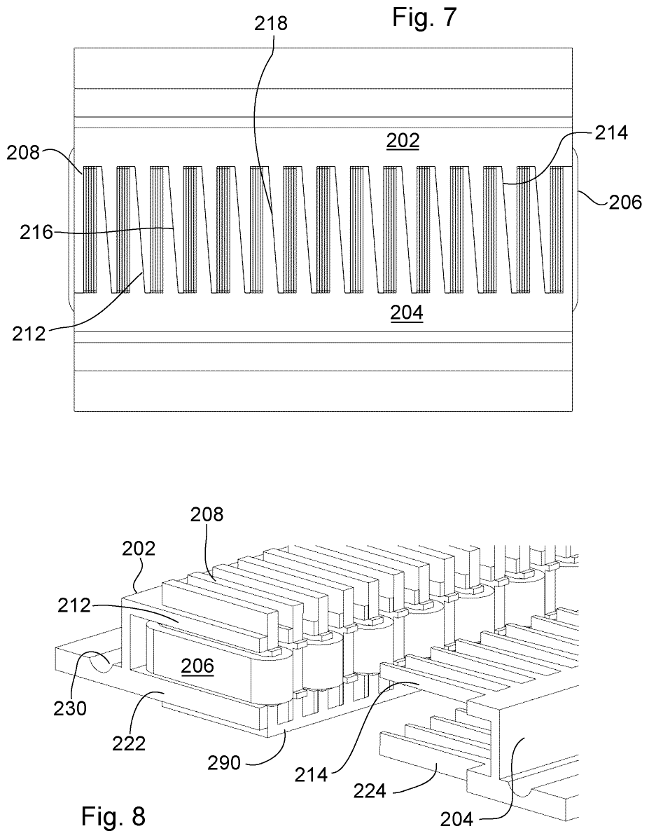

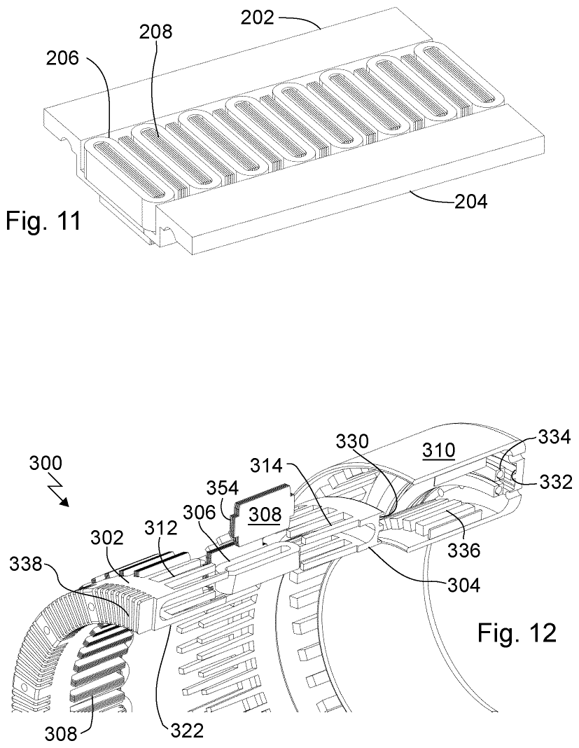

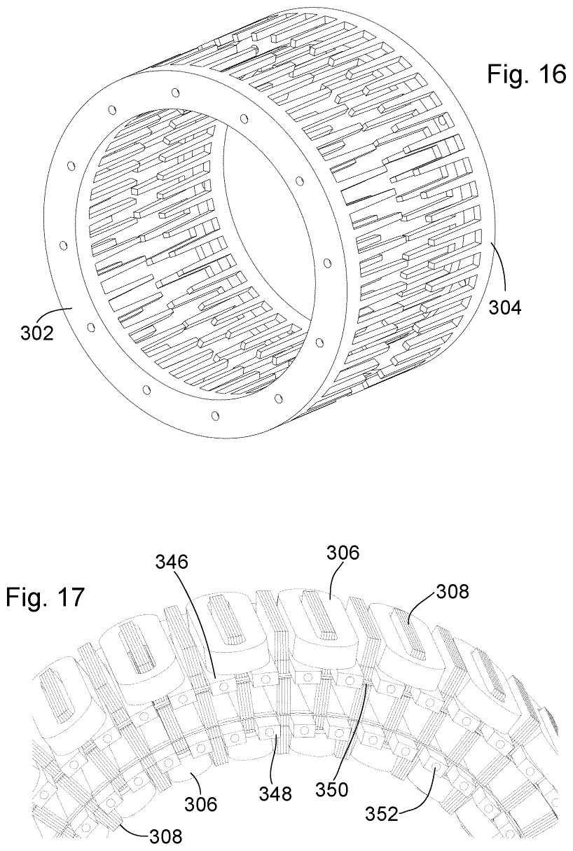

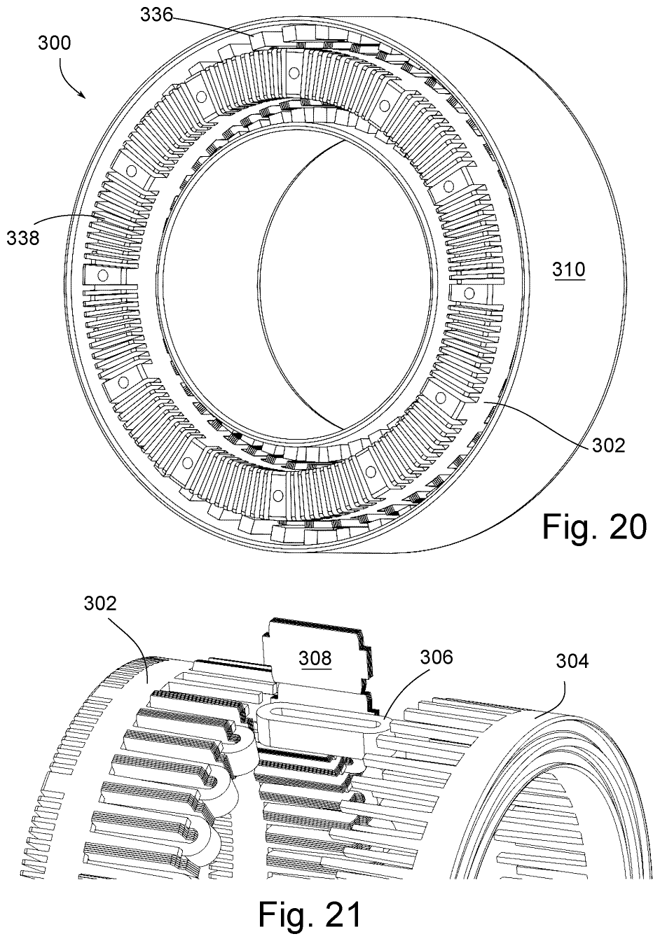

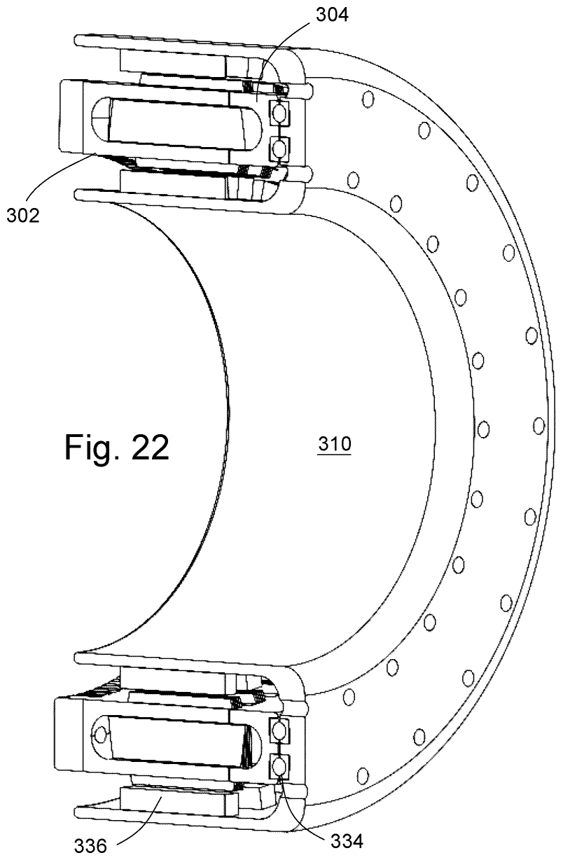

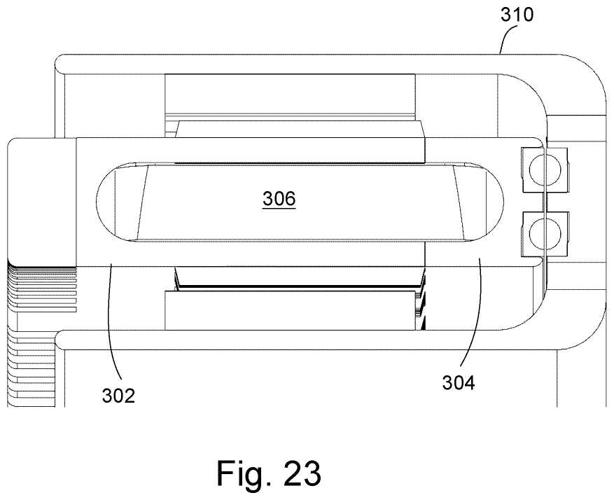

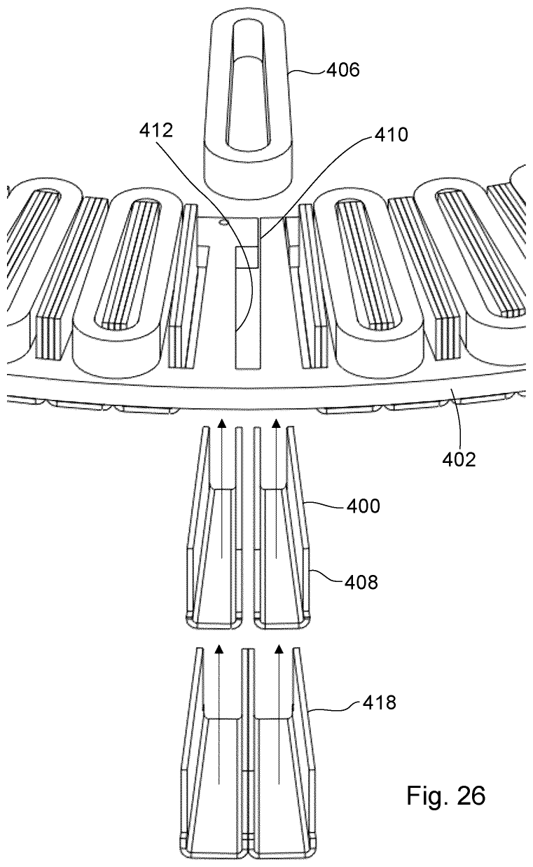

There are disclosed two main embodiments that allow for the elimination of a backiron. The first embodiment uses bent posts or staples, for example, as shown in the embodiments in FIGS. 26 to 28. The second embodiment uses a dual rotor configuration with rotors on opposed sides of the stator as shown, for example, in FIGS. 5 to 23. In that case, the flux is transmitted through the stator to the rotors on either side of the stator. The use of straight stator posts simplifies the production of the posts by allowing them to be punched and nested during the punching process to reduce wasted material, and makes it easier to achieve a higher precision device. In addition, the double rotor configuration provides a higher torque potential for a given axial length of motor.

Eddy currents may be reduced by utilizing laminations in the stator posts to reduce eddy currents in the posts, which may be steel. The structural members may also be interdigitated and made from a hard anodization aluminum material so that the contact between interdigitated fingers of the structural members prevent creation and flow of eddy currents around the posts which would otherwise be induced in the cage by the change in magnetic field in the electromagnetic stator posts. In embodiments of the device, the aluminum housing and fingers are spaced away from the airgap. Especially when used in combination with a high slot density stator and corresponding high number of magnets on the rotor, the magnetic field of the rotor is highly focused and does not reach too far past the airgap. By extending the posts past the aluminum housing and fingers, it is possible to use aluminum for the housing structure even though it would ordinarily generate high eddy currents in a low pole count motor where the larger magnets on the rotor have a greater reach into and past the airgap. As a non-limiting example, a 200 mm average airgap radial motor with 96 magnets on the rotor may have a magnetic field that is very strong at 0.25 mm from the rotor but relatively weak at 5 mm from the rotor. In this example extending the stator posts 3-5 mm past the aluminum housing and fingers will result in low enough magnetic field from the permanent magnets in the rotor to result in low enough eddy current production in the housing fingers that aluminum becomes a practical material for the housing.

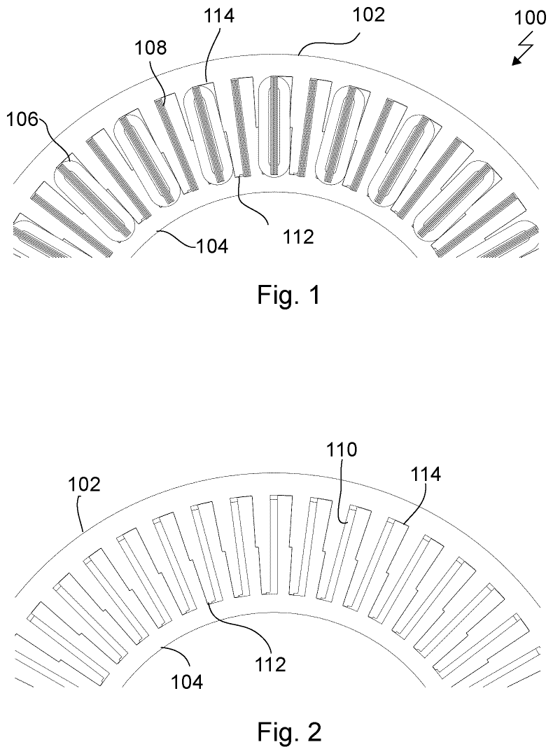

FIGS. 1 to 23 show embodiments of an interdigitated stator for an electric machine, including embodiments that are axial (FIGS. 1 to 4), linear (FIGS. 5 to 11) and radial (FIGS. 12 to 23). Each of these designs are similar in principle but are modified for the particular motor configuration.

FIGS. 1 to 4 show a stator cage 100 for an electric machine including a first structural member 102 having a first set of fingers 112 and a second structural member 104 having a second set of fingers 114 interdigitating with the first set of fingers and defining a plurality of slots 110 (FIG. 2) between the interdigitated fingers. A plurality of posts 108 (FIG. 1) are positioned in the plurality of slots 110. A plurality of coils 106 are connected around the plurality of posts. As shown in FIG. 1, the coils 106 are placed on every second post. The coils can be wired in a variety of ways.

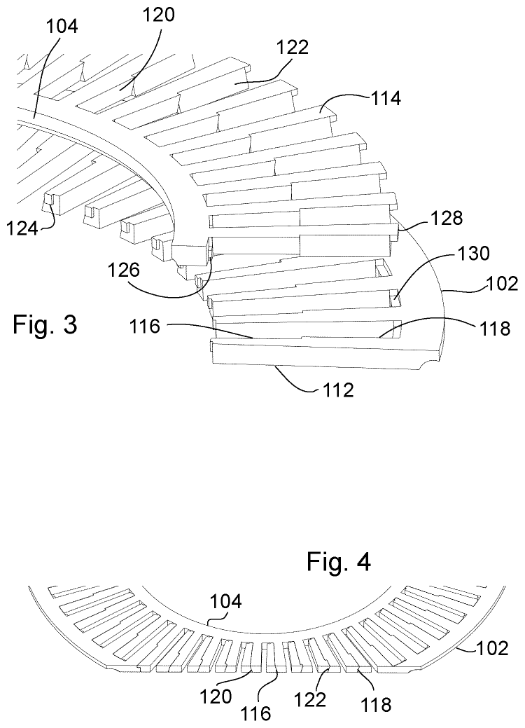

As shown in FIG. 3, the first structural member 102 has a first tapered surface having two first tapered faces 116, 118 on each of the first sets of fingers and the second structural member 104 has a second tapered surface on each of the second sets of fingers having two second tapered faces 120, 122. The two first tapered faces are sloped in different planes relative to the axis of the stator and the two second tapered faces are sloped in corresponding planes. Each of the fingers 112 has a first retaining tab 124. Each of the fingers 114 has a second retaining tab 128. The retaining tabs 124 sit within corresponding recesses adjacent to tab 126 and the retaining tabs 128 sit within corresponding recesses 130.

In FIG. 2, the fingers slot together axially and have features which lock them together and preload them in the tangential direction which holds the posts in place. As shown in FIG. 3 opposing sloped surfaces prevent tangential rotation. Once posts are inserted, the two axially-aligned “cage” elements will be locked together. Staples 400 (FIG. 25) may be used as posts.

A method of locking the first and second structural members 102, 104 can be described with reference to FIG. 3. Initially, the first and second structural members 102 and 104 are placed in axial alignment so that the first and second axial members 102, 104 are axially aligned above and below each other. The first and second structural members 102 and 104 are brought together axially so that the fingers 112 sit in the openings defined by adjacent fingers 114 and the fingers 114 sit in the openings defined by adjacent fingers 112. In this position, the tabs 128 sit in the recesses 130. The recesses 130 are wider than the width of the tabs 128 to allow for rotation of the first and second structural members 102, 104 relative to each other. Similarly, the tab 124 can move past tab 126 when placed in axial alignment. The first and second tapered surfaces are not initially in contact. The first and second structural members 102 and 104 are then rotated axially relative to each other so that the two first tapered faces 116, 118 are brought into contact with two second tapered faces 120, 122. Then the plurality of posts 108 are inserted into the slots 110 (FIG. 2) formed when the first and second tapered surfaces are brought into contact. The insertion of the posts assists in securing the first and second structural members 102, 104 in position since the first and second structural members 102, 104 are prevented by the posts from moving axially relative to each other. The tab 124 and tab 126 cooperate to prevent relative movement of the first and second structural elements 102, 104 when the first and second tapered surfaces are contacting and the posts are inserted.

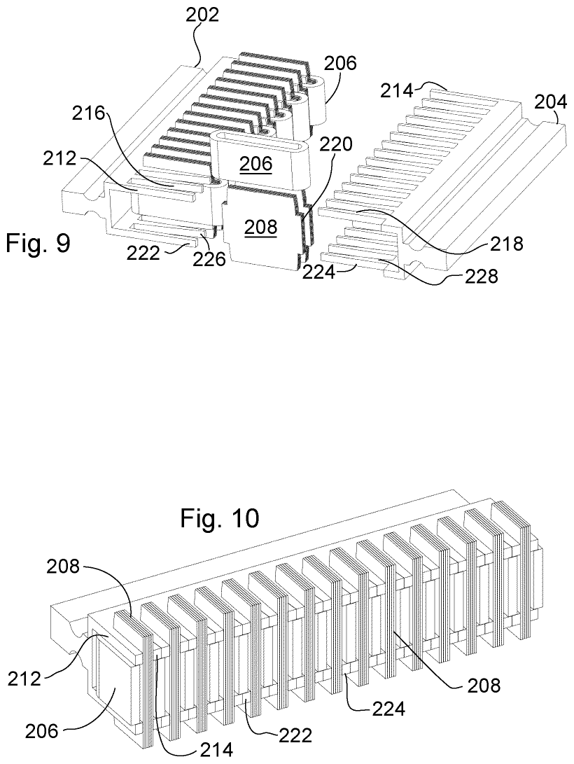

FIGS. 5 to 11 show embodiments of an interdigitated stator for a linear electric machine with a dual rotor configuration. A stator cage 200 for an electric machine is shown in FIG. 6. A first structural member 202 has two first rows of fingers 212, 222 (FIG. 8). A second structural member 204 has two first rows of fingers 214, 224 (FIG. 9) interdigitated with the first two rows of fingers and defining a plurality of slots between the interdigitated fingers (FIG. 6). A plurality of posts 208 are positioned in the plurality of slots. The interdigitated two first rows of fingers and two second rows of fingers define two rows of slots.

A plurality of windings 206 are connected around the plurality of posts. As shown in FIG. 8, each of the plurality of windings is connected around every second one of the plurality of posts. As shown in FIG. 10, each of the plurality of posts 208 are positioned between and extending beyond the two rows of slots. The posts have extending tabs 220.

FIG. 8 shows an embodiment of the linear motor having a backiron 290 rather than individual posts.

The first and second structural members 202, 204 and the plurality of posts 208 together form the cage 200 defining an enclosure 210 as shown in FIG. 5. The cage may contain a potting agent in the enclosure. The potting agent may be injected into the cage. The potting agent disclosed in this embodiment, and in other embodiments disclosed herein that have a potting agent within an enclosure in a stator cage, may preferably be conductive of heat but not electrically conductive.

As shown in FIG. 9, each of the fingers 212 have a tapered contact surface 216 and each of the fingers 222 have a tapered contact surface 226. Similarly, each of the fingers 214 and 224 have tapered contact surfaces 218 and 228, respectively. The tapered surfaces 216, 226, 218 and 228 are shown on each of the fingers, but the tapers need not be on every finger. When in a locked position, the tapered contact surfaces are in contact and preferably may form an interference fit. The tapered surface may also be tapered in a different direction than the one shown in FIG. 9 as long as a suitable lock is created by the first and second structural members. A loose fit between the fingers is also possible and a potting compound or other means may be used to secure the fingers together.

By moving the first and second structural members 202, 204 so that the interdigitated fingers are placed in contact with one another, a friction fit may be created. The friction fit ensures that the first and second structural members 202, 204 cannot be easily pulled apart. The tabs 220 (FIG. 9) on the posts 208 may function to maintain the first and second members 202, 204 in position so that the fingers 212 and 214 cannot slide past each other in a direction perpendicular to the plane defined by the linear stator. The coils may also assist in preventing the first and second members from separating. The tabs 220 also hold the posts in position within the cage 200.

As shown in FIG. 6, the coils 206 are surrounded by an aluminum structure which aids cooling. It is expected that in many applications that a potting compound would be drawn into the space inside the assembled housing occupied by the posts and coils. The potting compound will serve to secure everything into a solid structure and to conduct heat from the coils to the aluminum housings.

As shown in FIGS. 6 and 8, the first and second structural members have bearing grooves 30 in order to mount rotors on either face of the stator cage 200 using bearings.

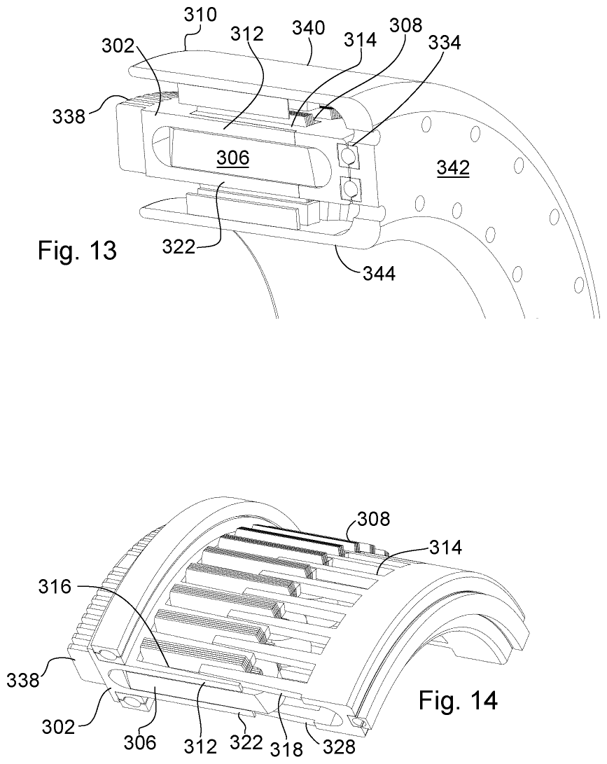

FIGS. 12 to 23 show a radial configuration of a stator cage 300 for a radial electric machine. There is a first structural member 302 having a first outer set of fingers 312 and a first inner set of fingers 322 and a second structural member 304 having a second outer set of fingers 314 and second inner set of fingers 324 (FIG. 14). The fingers 312 and 314 lie on the outer part of the stator and are interdigitated with each other and the fingers 322 and 324 lie on the inner part of the stator and are also interdigitated with each other. The fingers 312 and 314 define a plurality of outer slots between them and the fingers 322 and 324 define a plurality of inner slots between them and the inner and outer slots hold a plurality of posts 308. A plurality of windings 306 are connected around the plurality of posts 308. Each of the plurality of windings 306 is connected around every second one of the plurality of posts 308 and are encased within the cage 300 defined by the first and second structural members 302, 304 and the plurality of posts 308 as shown in FIG. 13. The cage defines an enclosure which may contain a potting agent as described above. The plurality of posts 308 are positioned between and extend beyond corresponding inner and outer slots. The posts have tabs 354 (FIG. 12) that are similar to tabs 220 in FIG. 9. The tabs 354 may assist in ensuring that the posts remain in position relative to the stator cage 300.

A double-sided rotor 310 having permanent magnets 336 is shown positioned around the stator and stator cage 300 in FIG. 12. As shown in FIG. 13, the rotor 310 includes an outer rotor 340 interconnected by a rotor structural member 342 to an inner rotor 344.

Concentric cage element 300 formed by structural members 302, 304 are spanned by posts 308. The fingers may be constructed from two cylinders with interlocking axially extending cage fingers 312, 314, 322, 324. The interlocking fingers are constructed from tapered interface surfaces which contact finger to finger.

As shown in FIG. 12, the first structural member 302 further comprises a plurality of cooling fins 338 on one side of the cage. The fins 338 provides a heat radiating feature which increase surface area to dissipate heat. Cooling fins may also be placed on the rotor. The second structural member 304 includes a bearing groove 330 for connection to bearings 334 and matching bearing grooves 332 on the dual rotor 310.

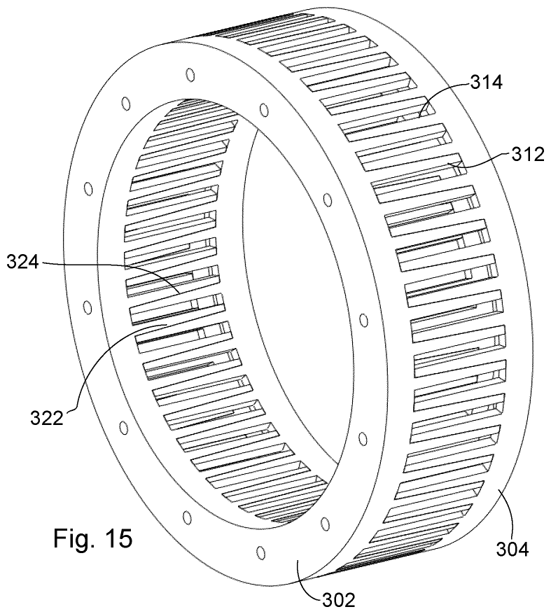

As shown in FIG. 14, as the tapered fingers slot together they will preload the posts holding them in place. Since the fingers extend around the two halves of the cage 300, the first and second structural elements will be held in place radially. The first and second structural members 302, 304 will resist any motions pulling them apart due to the friction fit created by the tapered interface surfaces. A loose fit between the fingers is also possible and a potting compound or other means may be used to secure the fingers together. In FIG. 15, the holes in the axial direction are for mounting.

FIG. 17 shows another embodiment of a radial stator having an outer structural member 346 and an inner structural member 348 that form fingers but are not interdigitated. Instead, the posts are held in place with retaining rings 350. The outer and inner structural members 346, 348 include mounting holes 352.

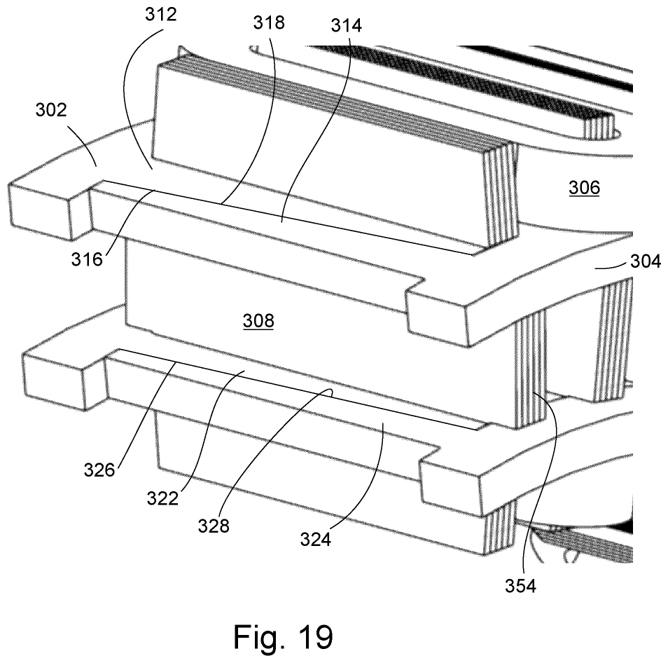

In FIG. 19, fingers 312, 314, 322, 324 may be axially extending aluminum fingers having tapered interface surfaces 316, 318, 326, 328 which contact (aluminum-to-aluminum). This tapered interface will allow easier assembly and it will also allow the aluminum members to be pressed together axially to clamp the posts into place. When the aluminum components are pressed together axially, the aluminum cylinder with the tapered fingers on one axial end of the assembly will rotate relative to the aluminum cylinders on the other axial end of the assembly (as a result of the tapered interface) and the width of the slots which house the posts will be reduced.

As shown in FIG. 19, the first outer fingers 312 each have a first outer tapered surface 316. The second outer fingers 314 each have a second outer tapered surface 318. The outer tapered surfaces 316 and 318 correspond and are in contact as shown in FIG. 15. Collectively, the first and second outer tapered surfaces form an interference fit. A loose fit between the fingers is also possible and a potting compound or other means may be used to secure the fingers together. The first inner fingers 322 each have a first inner tapered surface 326. The second inner fingers 324 each have a second inner tapered surface 328. The inner tapered surfaces 326 and 328 correspond and are in contact as shown in FIG. 15. Collectively, the first and second inner tapered surfaces form an interference fit. A loose fit between the fingers is also possible and a potting compound or other means may be used to secure the fingers together.

As shown in FIGS. 1 to 23, there are embodiments with a single stator and a double rotor which may eliminate the need for a back iron because the cage defined by the first and second structural elements, in concert with the coils on either side of the stator provide a flux path in a manner similar to the function of a traditional back iron. By using posts which go from one airgap on one rotor to other airgap on other rotor, flux goes right through, with the coils in-between in each of the radial, axial or linear configuration. The posts may be made from laminations. The coils can be placed on every second post and could be wired in a variety of ways.

The stators may be held together with two sets of interdigitated fingers that come together and leave a space on one side for posts and have a taper to clamp the posts. By using an interdigitated structure, eddy currents can be reduced. The interdigitated structure provides eddy current breaks. The cage formed of the first and second structural elements may form a fully aluminum enclosed structure. Aluminum may be preferable because it can be anodized (preferably hard anodized, for electrical insulation) and it is low cost, allows high heat capacity and low resistance heat transfer and is easily manufacturable.

The aluminum may be hard anodized. A hard-anodized coating which is created before assembly will block eddy current paths around the stator posts. The use two-piece interdigitation blocks path which allows for the use of an aluminum structure that would otherwise develop eddy currents.

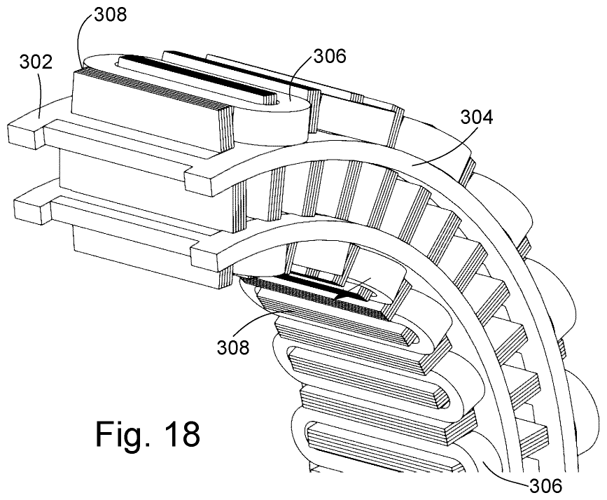

The posts may be made of steel and may extend past a radius of the cage, such as for example shown in FIGS. 17 and 18. The posts extend to reach the outer edge of a useful radius of magnetic fields created by magnets on the rotor. Longer poles may assist in preventing eddy current formation in the fingers as a result of the rotor movement past the stator. Eddy currents may form in aluminum due to rotor magnets moving past the stator but also from the switching of the internal coils.

Using a cage structure with interdigitated fingers may provide a solid structure with a locking taper that is very rigid. The tube-like cage structure formed when the first and second structural members are joined together allows for injection of a potting compound as described above.

The cage keeps the coils and other internals electrically insulated which may prevent short circuits. Aluminum conducts heat away from coils and insulates coils from magnets, which may allow the motor configurations to run hotter and thereby provide more power output.

The stators may also be designed with cooling channels to facilitate the flow of ambient air or forced air or other cooling fluid. The coils may be placed inside or outside of the cages formed by the first and second structural members. As shown in FIG. 14, the coils are shown on the inside which may provide cooling or structural advantages.

The embodiments describe may allow for the creation of a low-cost stator having high torque. The embodiments may have a high pole count, as shown, and the rotor magnetic field may be very concentrated, for example having minimal permanent magnet force at 5 mm, resulting in minimal eddy currents in the aluminum housing if the stator posts extend 3-5 mm past the aluminum features.

Some benefits that may arise from the embodiments disclosed herein include high speed due to the ability to use laminated posts and a dual rotor design that allows for increased torque.

Laminations may be used for the posts in some embodiments for decreased eddy currents instead of solid posts. Solid posts are possible since a high pole count may cause the posts to act somewhat like laminations. Electrically insulated soft magnetic powdered materials may be used for the posts. Having additional cooling provided by the enclosed cage and heat dissipation from aluminum may allow for higher current for more power, or may allow for the same power usage and increased durability and lifespan due to cooler temp and decreased degradation of coil insulation.

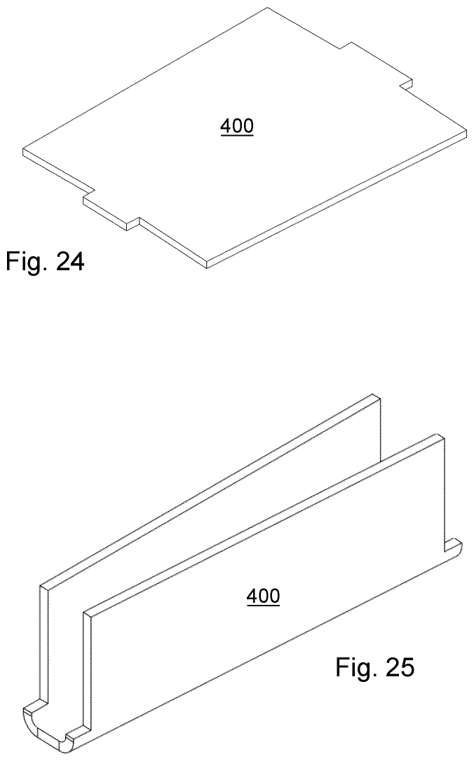

FIGS. 24 to 28 show an axial flux motor with staples for use with a single rotor, instead of a dual rotor design. Each of the staples provides the function of a backiron from one half of each post to the other half of an adjacent post.

A single piece of ferrous material 400 in FIG. 24 is formed into the staple 400 having the shape shown in FIG. 25 by bending or stamping or pressing or other suitable method to form a bent piece of ferrous material. Staples use an extended section or tab as a precision locating feature against the housing.

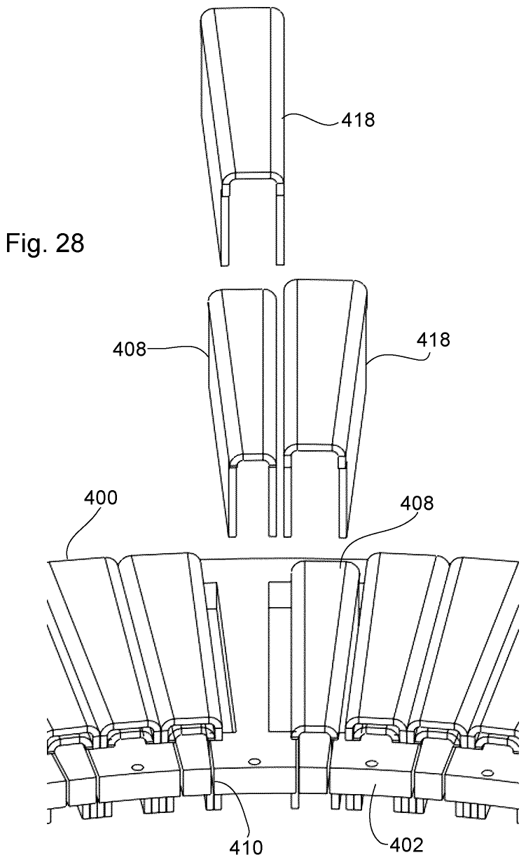

As shown in FIG. 26, there is a stator for an electric machine having a structural member 402 in the shape of a disk that defines a plurality of slots 412. A plurality of posts 408 formed by placing staples 400 adjacent to one another are inserted through the plurality of slots. The windings 406 are connected around the plurality of posts. The windings are connected around every second one of the plurality of posts. As shown in FIG. 26, the staples 400 may comprise two individual bent pieces 408 and 418 that are nested together. Different numbers of bent pieces may be nested together to form the staples. As shown in FIG. 28, the base of the bent piece 408 is narrower than the base of the bent piece 418 to allow for the two pieces to be nested without compressing or potentially damaging the bent piece 408 during the nesting process. In some designs, the staples may instead be formed from the single piece of material. The coils 406 are placed around the legs of two adjacent staples as shown in FIG. 26.

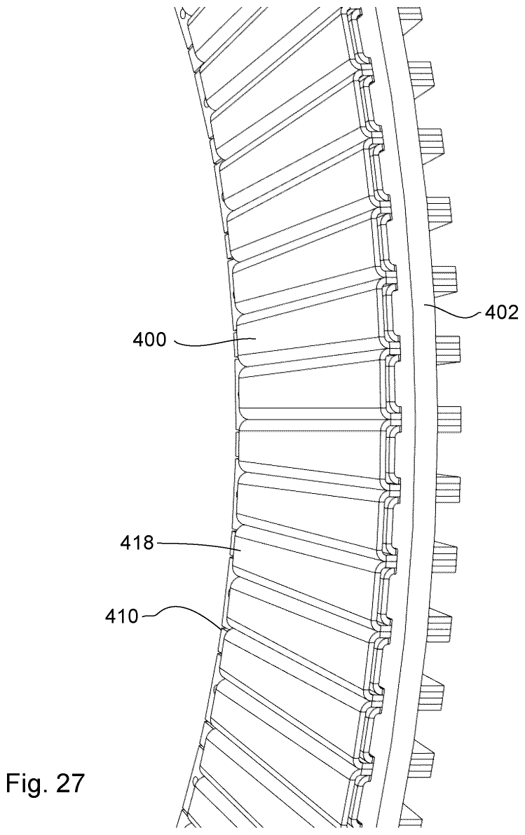

As shown in FIG. 27, the staples include a gap between the bent portion of the staple 400 and the aluminum housing opposite the airgap which may allow cooling air flow. The staples may have two or more layers of laminate with a gap between the bent portions of the two or more layers to provide cooling airflow and to prevent interference of the bent sections of the two or more layers.

Eddy current cuts 410 (FIG. 28) are used to reduce the formation of eddy currents.

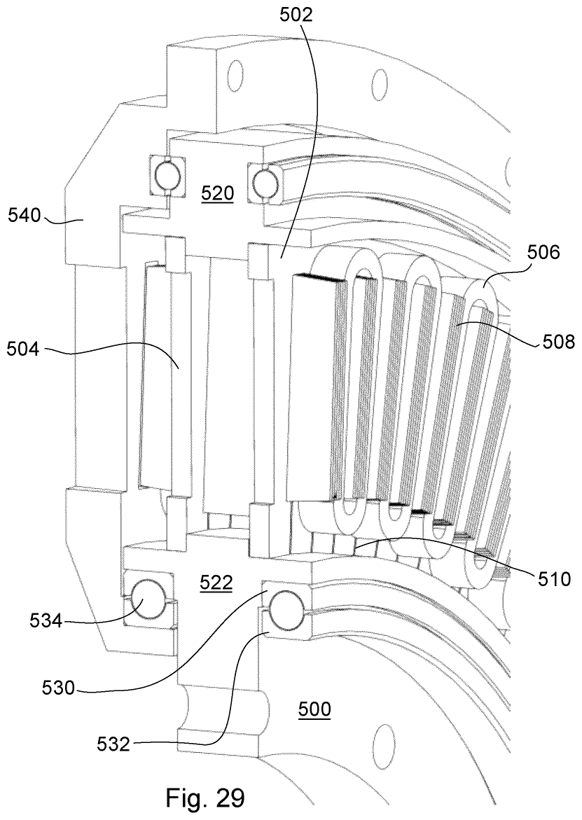

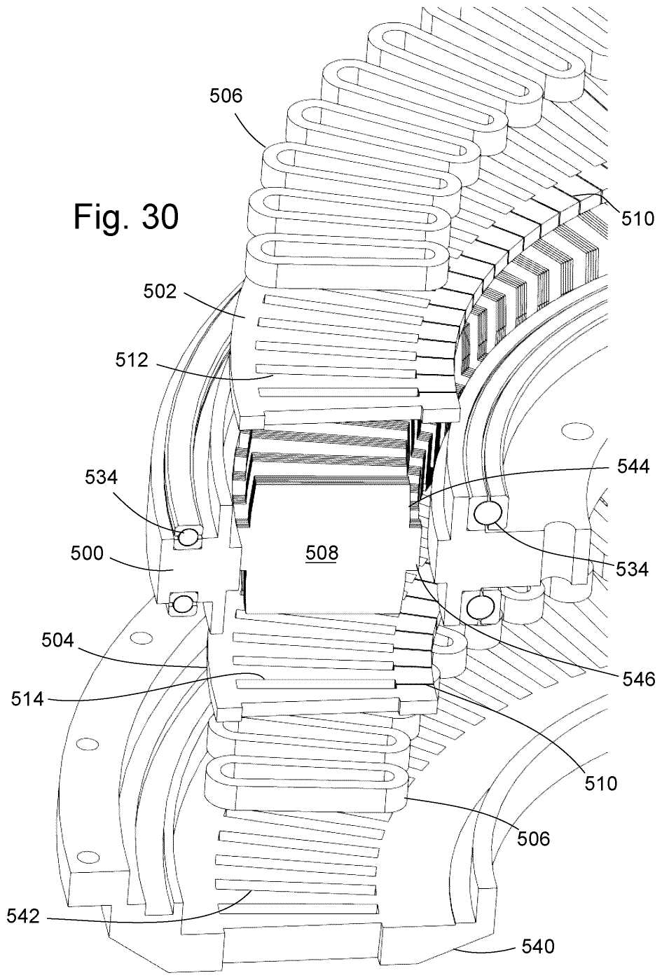

FIGS. 29 to 31 show a portion of an embodiment of an axial stator cage 500 for an electric machine. As shown in FIG. 30 a first structural member 502 and a second structural member 504 are connected to inner and outer structural pieces 520 and 522 to collectively form the cage 500 that defines an enclosure. The cage may serve some of or all of the following purposes: structural member, flux path, cooling.

FIG. 29 shows an axial flux exemplary embodiment of the device. The two structural members 502, 504 may be aluminum disks that are positioned on either side of an ID and OD bearing housing ring.

The first structural member includes a first plurality of slots 512 (FIG. 30) and the second structural member includes a second plurality of slots 514 (FIG. 30). The first and second structural members include eddy current breaks in the form of eddy current cuts 510 that reduce the production of eddy currents. A plurality of posts 508 are housed within corresponding slots of the first plurality of slots 512 and the second plurality of slots 514. As shown in FIG. 29, each of the plurality of posts is inserted into and extend between and through the corresponding slots of the first and second plurality of slots.

The use of a single contiguous cylindrical element to form a stator could allow for the formation of undesirable eddy currents. The use eddy current cuts 510 may interrupt eddy currents which could form in the cage. As shown in FIG. 30, eddy current cuts 510 are placed adjacent to each of the plurality of cage slots 512, 514 which may interrupt eddy currents forming in the cage.

As shown in FIG. 30, the first structural member 502 is a first disk and the first plurality of slots 512 are arranged radially around the first disk. The second structural member 504 comprises a second disk and the second plurality of slots 514 are arranged radially around the second disk. The cage is constructed from the first and second disks stacked axially with faces parallel.

The first and second plurality of slots 512, 514 hold the plurality of posts 508 in place axially. Coils 506 are wrapped around the plurality of posts 506 outside of the cage on either side of the stator.

The double rotor design as shown in FIG. 29 may effectively eliminate the need for a back iron because the cage 500 in concert with the posts 508 on either side of the stator 500 provide a flux path in a manner similar to the function of a traditional back iron. A rotor 540 is shown mounted on the stator in FIG. 29. In FIGS. 29 to 31, one of the two rotors is not shown but may be a mirror image of the rotor 540. The thrust bearings around the outer diameter may or may not be necessary depending on the rigidity of the rotors and stator. For high speed applications such as wheel motors and other devices, a pair of smaller diameter inner diameter bearings with no outer bearings may allow higher speeds.

In the embodiment shown, the posts 508 may be made of solid material such as steel or iron, but may also be made from laminates, as shown here, or powdered magnetic materials such as but not limited to ferrite. The posts have axial extending tabs 546 and radially extending tabs 544.

The rotors may be bolted together, sandwiching the stator cage 500 inside, to increase structural rigidity and to maintain an optimal air gap between coils 506. The rotors have rotor slots 542 (FIG. 30) for housing permanent magnets (not shown) radially about the rotors. FIG. 30 shows simplified coils 506 with no connections between coils.

The rotor 540 and cage 500 may be mounted together using bearings. The bearings may include inner and outer bearing races 530, 532. There may be four bearings 534, two on each side of the stator and including two inner bearings and two outer bearings as shown in FIG. 29.

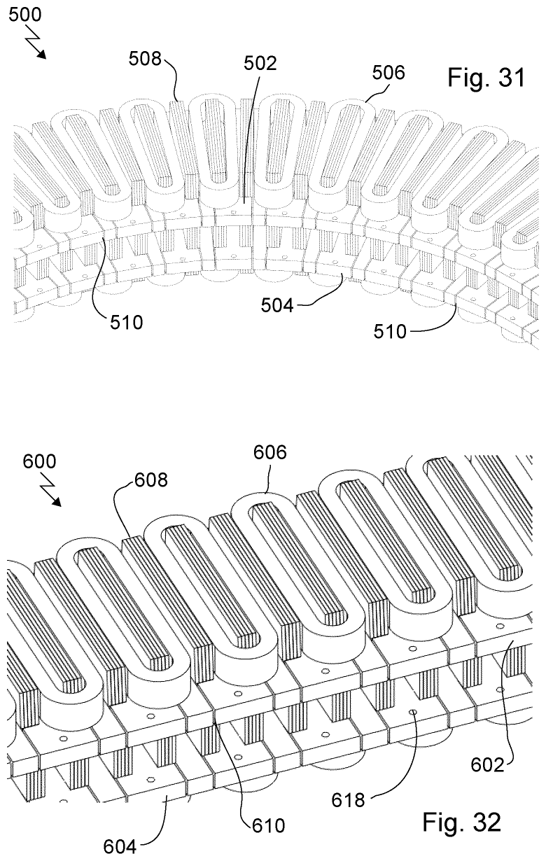

FIGS. 32 to 34 show an embodiment of a linear stator having a corresponding design to the axial stator shown in FIGS. 29 to 31.

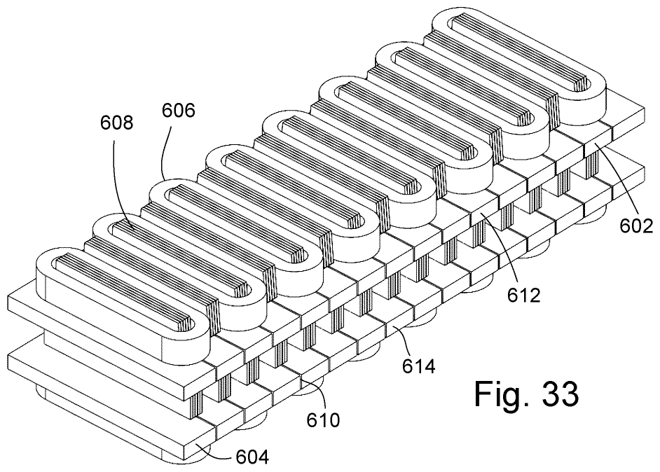

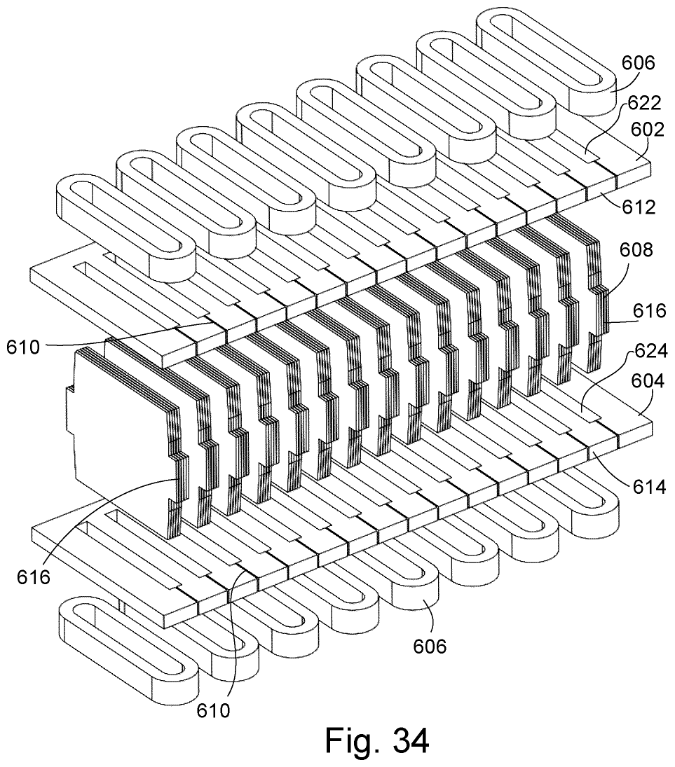

A linear stator cage 600 for an electric machine includes a first structural member 602 and a second structural member 604. As shown in FIG. 32, the first and second structural members are plates. The first plate 602 includes a first plurality of slots 622 (FIG. 34) arranged in a row along the first plate and the second plate 604 includes a second plurality of slots 624 (FIG. 34) arranged in a row along the second plate. A plurality of posts 608 are positioned within the plurality of slots 622, 624. The stator has eddy current breaks in the form of eddy current cuts 610 on each of the first and second plates 602, 604, thereby forming fingers 612 and 614. Coils 606 extend around every second post 608 (FIG. 33). Posts 608 have tabs 616 and as shown in FIG. 32 that can be used to ensure that the posts are fixed between the first and second plates 602, 604. There are mounting holes 618 in the first and second plates 602, 604.

The hard-anodized aluminum plates which position the stator posts have an eddy current cut 610 at each post that eliminates an electrical circuit from being formed around each post. The fingers that remain are aligned to withstand the greatest forces on the structure which result from the attraction between the stator and rotors.

As shown in FIG. 33, the stator cage 600 is a flat construction which is used with a linear actuator (not shown).

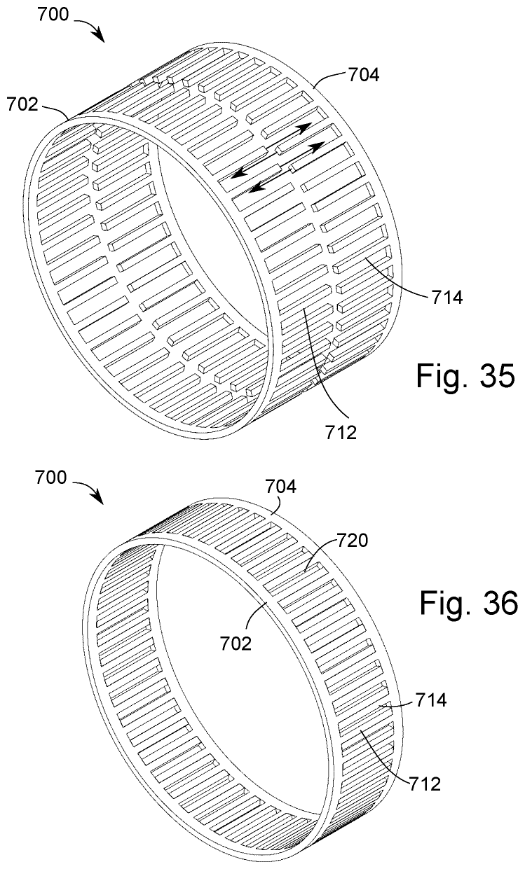

As shown in FIG. 35, are structural members 702 and 704 for a stator cage 700, having individual fingers 712 and 714 that contact each other which can increase strength and reduce flexure radially due to friction between surfaces between the fingers. A plurality of slots 720 are formed when the stators are locked together. FIG. 35 shows the fingers in a separate position and FIG. 36 shows the fingers locked together. The design in FIGS. 35 and 36 are similar to the design shown in FIG. 15, except that there is only one set of first and second fingers, rather than inner and outer sets as in FIG. 15. The fingers shown in FIG. 35 may be tapered in the same manner as the fingers shown in the embodiment in FIG. 15 or tapered in a different manner so that the resulting structure is locked in position and can withstand the electromagnetic forces created by the motor.

This orientation features tapered fingers 712, 714 which are pressed together. This pressure may result in preload in the fingers between the surfaces of the fingers. The resulting friction along the faces of the fingers will hold the fingers in contact with each other and clamp the posts into place as the tips of the fingers will not be free to move. Since the fingers are locked together in a cylindrical shape, the structural members 702 and 704 will be locked in all directions once the fingers are interdigitated with an interference fit. A loose fit between the fingers is also possible and a potting compound or other means may be used to secure the fingers together.

The geometric rectangular shape of the ends of the fingers and of the base where the fingers nestle between opposing fingers also helps restrict movement.

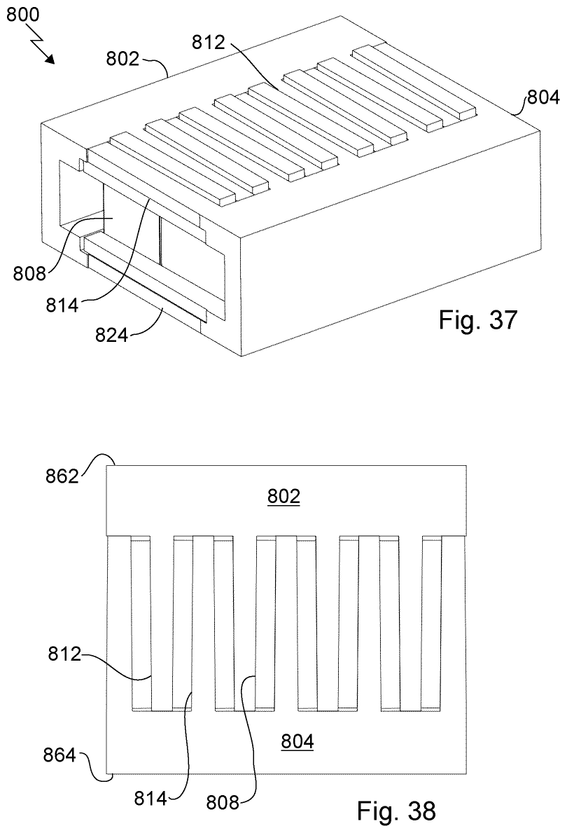

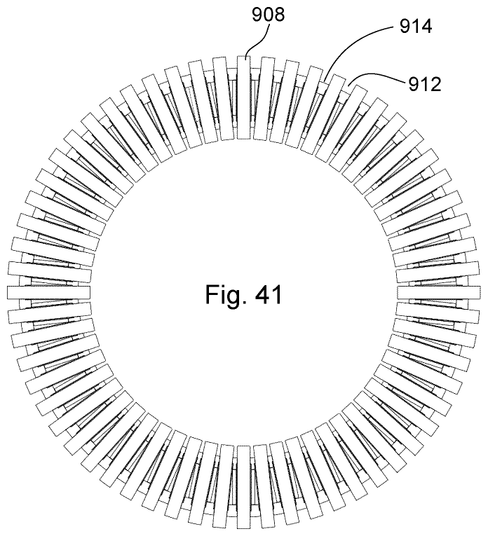

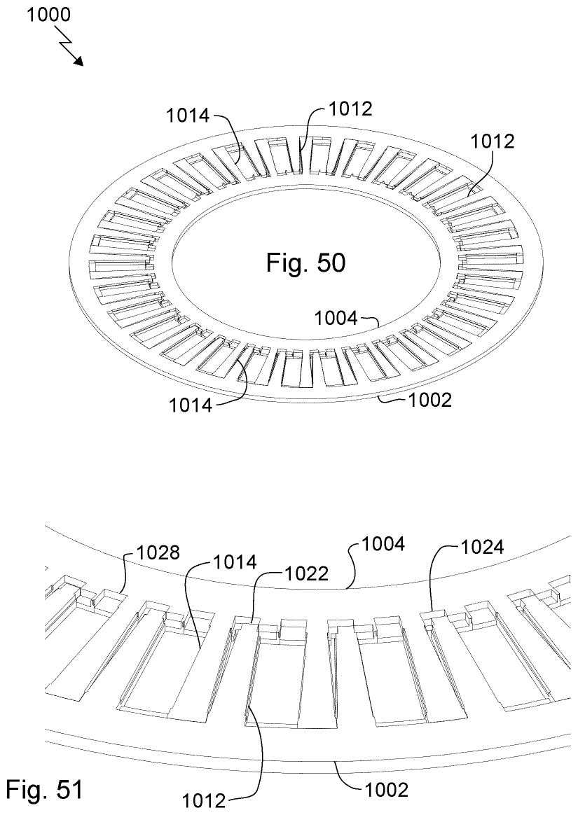

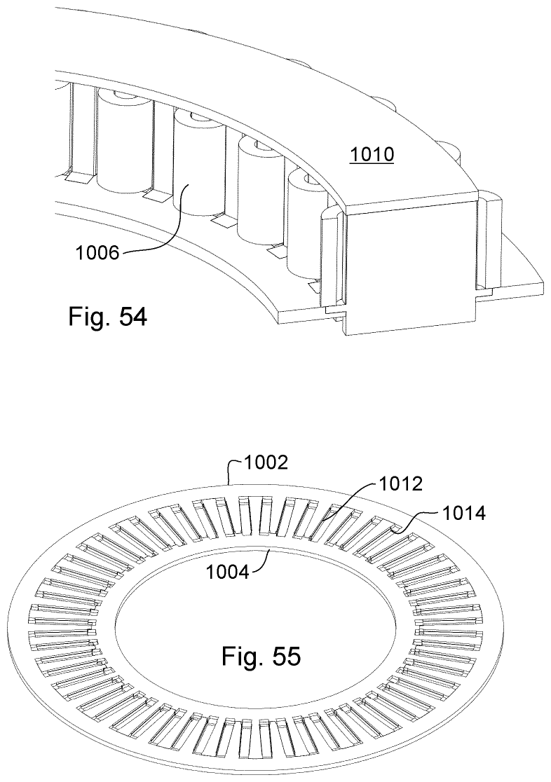

FIGS. 37 to 59 show embodiments of linear (FIGS. 37-40), radial (FIGS. 41-49), and axial stators (FIGS. 50-59) which utilize a different pattern of interdigitation from that disclosed in the previous figures. This pattern places two posts between adjacent fingers of each structural member.

A linear stator cage 800 is shown in FIG. 37. The cage is formed by a first structural member 802 and a second structural member 804. The first structural member 802 has first upper fingers 812 and first lower fingers 822. The second structural member 804 has second upper fingers 814 and second lower fingers 824. It will be understood that the terms ‘upper’ and ‘lower’ in relation to a linear motor are terms that are used for ease of reference and refer only to the orientation of the stator as shown in the drawings.

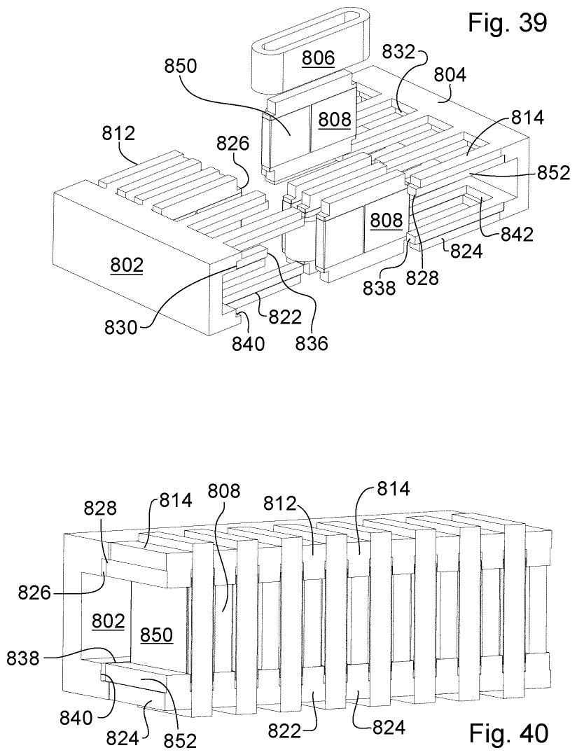

Posts 808 are placed between the slots defined by the first and second structural members 802, 804 as shown in FIG. 37. As shown in FIG. 39, windings 806 are placed around the posts 808. The posts 808, represented as solid blocks, may be formed from materials such as but not limited to: stacks of steel laminations, solid material, powdered ferromagnetic material (such as Dura-Bar™), etc.

Insulative/protective coating including but not limited to Nomex™ paper 850 (FIG. 39) is shown wrapped around stator posts and is meant to electrically insulate the coils from the posts.

The fingers 812, 814, 822 and 824 include tabs 826, 828, 836 and 838 respectively at the ends of the fingers that cooperate with corresponding recesses 832, 830, 842 and 840 respectively to hold the first and second structural members in position. The tabs/shoulders at the ends of the fingers constrain the fingers in the radial direction.

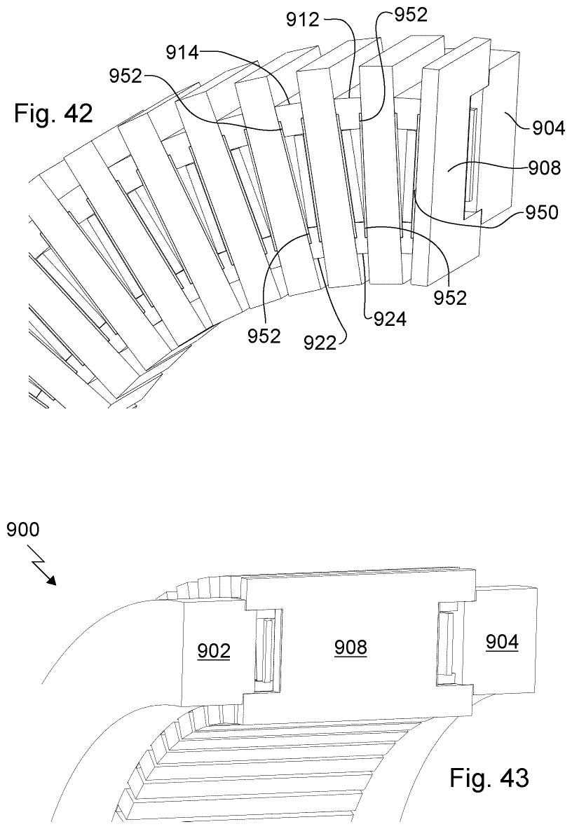

The interdigitated fingers feature recesses 852 (FIG. 40) to accommodate the layer of insulation 850. This recess allows the paper to extend below the furthest reach/base of the coil. A similar configuration is shown in the radial configuration in FIG. 42.

The fingers shown in the linear embodiment are tapered as shown in FIG. 38. The tapered fingers constrain the fingers from pulling apart. As shown in FIG. 38, the fingers 812 are tapered so that they narrow as they extend away from a main body 862 of the first structural member 802. The fingers 814 also are tapered so that they narrow as they extend away from a main body 864 of the second structural member 804. As the first and second structural members are placed together so that the fingers are interdigitated, the two halves together form a locking taper/friction fit after creating a wedging effect between fingers 812, 814 and posts 808 as shown in FIG. 38. The narrowing taper of each of the fingers 812, 814 allow for the formation of the interference fit. The tapered fit between the fingers 812, 814 and posts holds the first and second structural members in position so that they do not readily separate. A loose fit between the fingers is also possible and a potting compound or other means may be used to secure the fingers together. There are many additional ways the halves could be secured together such as a securing outer shell, clips on the fingers, fasteners, etc.

By having a slight taper on all of the fingers, the posts 808 are at a slight angle to each next post. This allows the fingers 812 and 814 to be tapered for moldability and to allow them to be assembled more easily. The angled posts can also reduce cogging. FIGS. 41 to 49 show an embodiment of a radial stator having a similar design to that shown in FIGS. 37 to 40 but modified to be radial rather than linear.

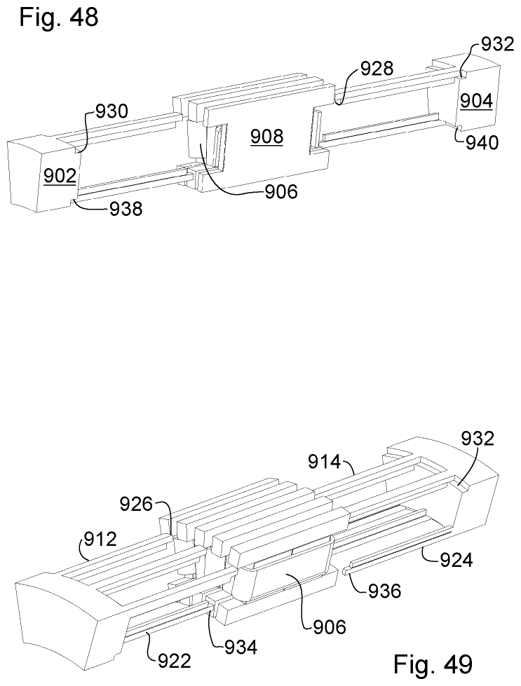

As shown in FIG. 43, there is a first structural member 902 and a second structural member 904 which are interdigitated to support posts 908 to form a cage 900. Coils 906 (FIG. 49) are placed on every second post 908. As shown in FIGS. 48 and 49, first outer fingers 912 have tabs 926 that cooperate with recesses 932 on the second structural member 902. Second outer fingers 914 have tabs 928 that cooperate with recesses 930 on the first structural member 902. First inner fingers 922 have tabs 934 that cooperate with recesses 940 (FIG. 48) on the second structural member 904. Second inner fingers 924 have tabs 936 that cooperate with recess 938 on the first structural member 902.

A heat insulation layer may be placed around the outside and/or inside of the stator to fill the airgap. This layer may insulate the rotor magnets from the heat of the stator, which may benefit magnet cost and the ability to run the stator hotter. The insulation layer can reduce the chopping of the air between the rotor and stator in the airgap (causing windage noise).

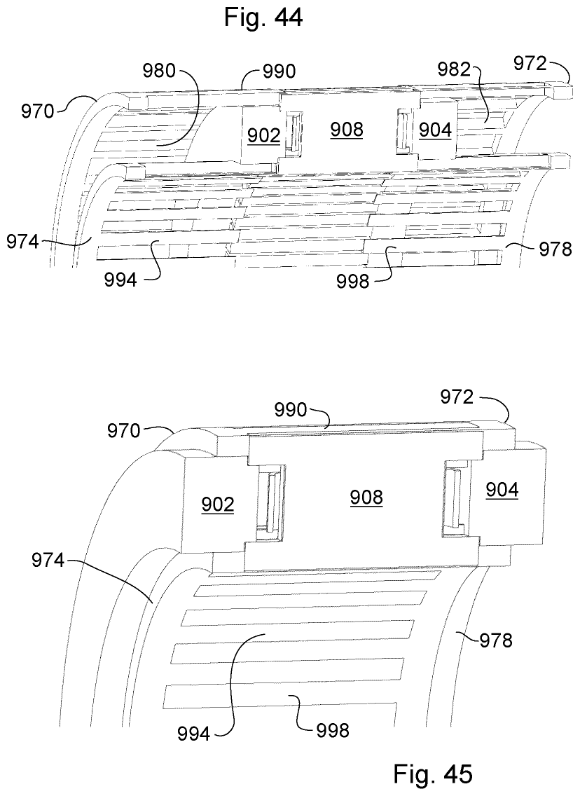

FIGS. 44 to 47 shows two interdigitated ceramic insulation rings forming a heat insulation layer surrounding the stator cage. Each of the ceramic insulation rings are formed from two interdigitated halves. An outer ceramic insulation ring is formed from a first outer insulation member 970 interdigitated with a second outer insulation member 972. An inner ceramic insulation ring is formed from a first inner insulation member 974 interdigitated with a second inner insulation member 978.

Each of the insulation members include fingers having a rigid portion and a flat portion. The first outer insulation member 970 has fingers with rigid portion 980 and flat portion 990. The second outer insulation member 972 has fingers with rigid portion 982 and flat portion 992. The first inner insulation member 974 has fingers with a rigid portion 984 and flat portion 994. The second inner insulation member 978 has fingers with a rigid portion 988 and a flat portion 998.

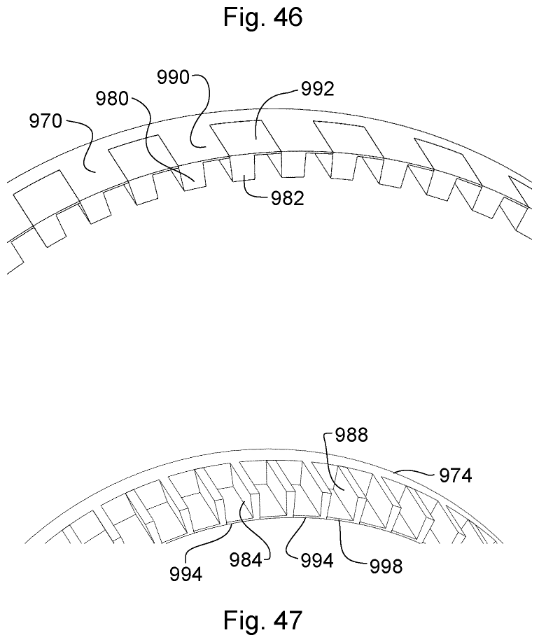

As shown in FIG. 44, the rigid portions 980, 982, 984 and 988 extend radially outward and are interdigitated with posts 908 sitting in between. As shown in FIGS. 46 and 47, the flat portions 990, 992, 994 and 998 form two complete cylinders when the two corresponding insulation members are put together to form the ceramic insulation rings. A potting agent can be injected into the opening between the first and second structural members 902, 904 and the inner and outer ceramic insulation rings.

In the radial embodiment in FIG. 42, the fingers are tapered towards the central axis of rotation so that when the fingers are pressed together, the posts wedge in-between the fingers at an angle due to the tapering of the fingers. The fingers also include recesses 952 which accommodates a layer of insulation 950 on the posts.

FIGS. 50 to 59 show an embodiment of an axial stator having a similar design to those shown in FIGS. 37 to 49 but modified to be axial and without multiple layers of fingers.

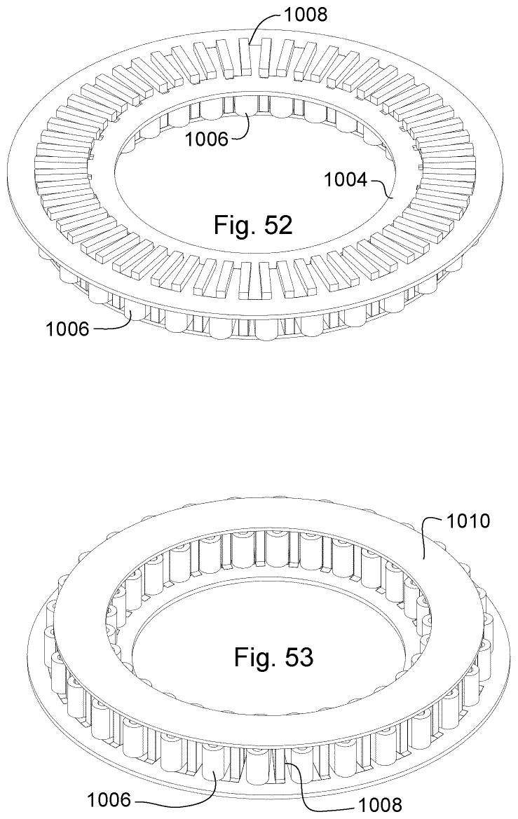

In FIG. 50, a stator ring 1000 is shown having a first structural member 1002 having fingers 1012 and a second structural member 1004 having fingers 1014. The first and second structural members 1002, 1004 are disks. The ring 1000, which holds the posts in place, are formed from two axial disks 1002, 1004 that overlap and interlock as shown in FIGS. 50 and 51. Once the disks 1002 and 1004 are interlocked, posts 1008 are inserted as shown in FIG. 52 followed by coils 1006 and a backiron 1010.

The fingers 1012 each have tabs 1022 that cooperate with recesses 1024 in the second structural member 1004. The fingers 1014 each have tabs 1026 that cooperate with recesses 1030 in the first structural member 1002. The cooperating recesses and tabs hold the ring 1000 in position. Recess 1028 allows for the posts 1008 to be secured on the ring.

Each of the sets of fingers 1012 and 1014 expand in the outward radial direction. That is, the fingers 1012 narrow in the direction closer to the axis of rotation of the electric machine and the fingers 1014 expand in the direction away from the axis of rotation of the electric machine.

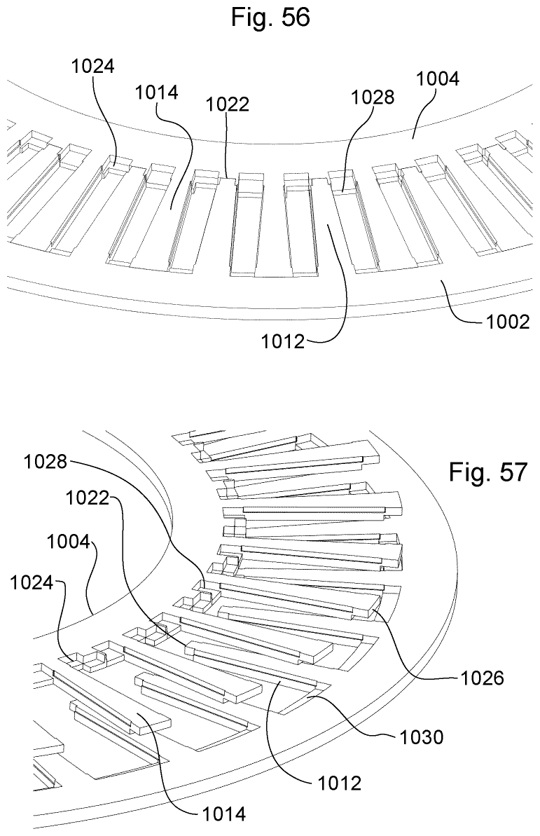

A method of locking the first and second structural members 1002, 1004 can be understood by considering the embodiments in FIGS. 56 and 57. Initially, the first and second structural members 1002 and 1004 are placed in axial alignment so that the first and second axial members 1002, 1004 are axially aligned with the disk 1004 above the disk 1002 as shown in FIG. 57. The disks 1002 and 1004 are brought together radially so that the fingers 1014 sit in the openings defined by adjacent fingers 1012 with the tabs 1026 sitting in the recesses 1030. The recesses 1030 are wider than the width of the tabs 1028 to allow for rotation of the disks 1002, 1004 relative to each other. Similarly, the tab 1022 can be placed in the recess 1024 as shown in FIG. 56 without the fingers 1014 and 1012 being directly in contact. Initially, the fingers 1012 and 1014 are not initially in contact. The first and second structural members 1002 and 1004 are then rotated axially relative to each other until they sit in the position shown in FIG. 56. As shown in FIG. 51, when the first and second disks are rotated into position, the widest parts of the fingers 1012 and 1014 are in contact with each other. Then the plurality of posts 1008 are inserted into the slots formed when the first and second tapered surfaces are brought into contact. The insertion of the posts assists in securing the first and second structural members 1002, 1004 in position since the first and second structural members 1002, 1004 are prevented by the posts from moving axially relative to each other.

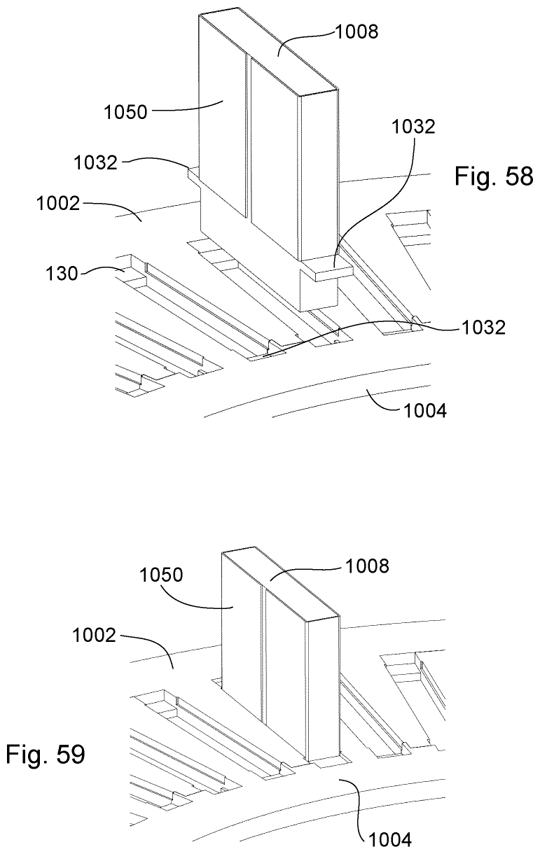

As shown in FIGS. 58 and 59, the posts 1008 have tabs 1032 on either side that cooperate with recesses 1030 and 1032 in the first and second structural members 1002, 1004. Insulative/protective coating including but not limited to Nomex™ paper 1050 is shown wrapped around stator posts and is meant to electrically insulate the coils from the posts.

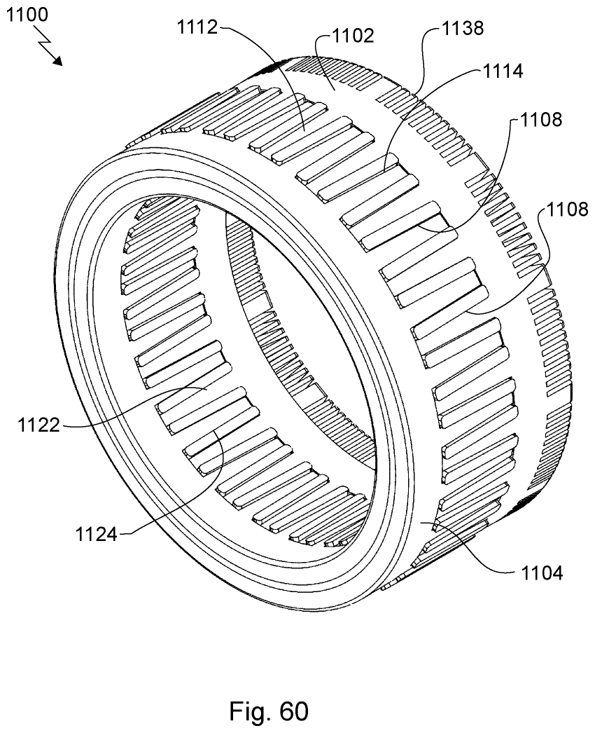

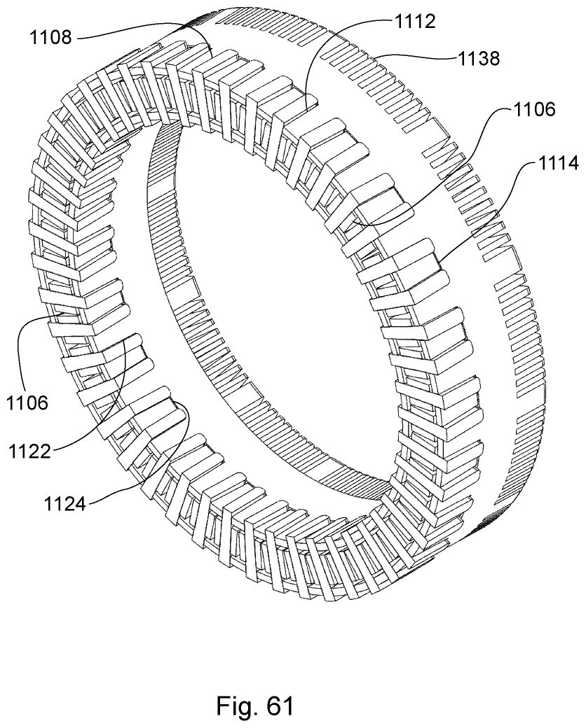

FIGS. 60 to 63 show a radial configuration of a stator cage 1100 for a radial electric machine. There is a first structural member 1102 having a first outer set of fingers 1112 and a first inner set of fingers 1122 and a second structural member 1104 having a second outer set of fingers 1114 and second inner set of fingers 1124. The fingers 1112 and 1114 lie on the outer part of the stator and the fingers 1122 and 1124 lie on the inner part of the stator. The fingers 1112 and 1114 define a plurality of outer slots between them when they are interdigitated and the fingers 1122 and 1124 define a plurality of inner slots between them when they are interdigitated and the inner and outer slots hold a plurality of posts 1108. A plurality of windings 1106 are connected around the plurality of posts 1108. The plurality of windings 1106 are connected around every second one of the plurality of posts 1108 and are encased within the cage 1100 defined by the first and second structural members 1102, 1104 and the plurality of posts 1108 as shown in FIG. 61. The cage 1100 defines an enclosure which may contain a potting agent. The plurality of posts 1108 are positioned between and extend beyond corresponding inner and outer slots.

As shown in FIG. 60, the corresponding sets of outer interdigitated fingers 1112 and 1114 and inner interdigitated fingers 1122 and 1124 are each tapered so that the width of each of the fingers become narrower in a direction away from the main bodies of the corresponding structural members 1102 and 1104. As shown in FIG. 60, the posts are angled relative to each other because of the tapers of the interdigitated fingers. By having a slight taper on all of the fingers, the posts 1108 are at a slight angle to each adjacent post. The alternating angles of the posts 1108 therefore allows a production method such as die casting to be used, and can also be used to reduce cogging.

Concentric cage element 1100 formed by structural members 1102, 1104 are spanned by posts 1108. The fingers may be constructed from two cylinders with interlocking axially extending cage fingers 1112, 1114, 1122, 1124. The interlocking fingers have tapered interface surfaces which wedge the corresponding fingers between and against the posts 1108.

As shown in FIG. 60, the first structural member 1102 further comprises a plurality of cooling fins 1138 on one side of the cage. The fins 1138 provides a heat radiating feature which increase surface area to dissipate heat. Cooling fins may also be placed on the rotor or on the second structural member 1104.

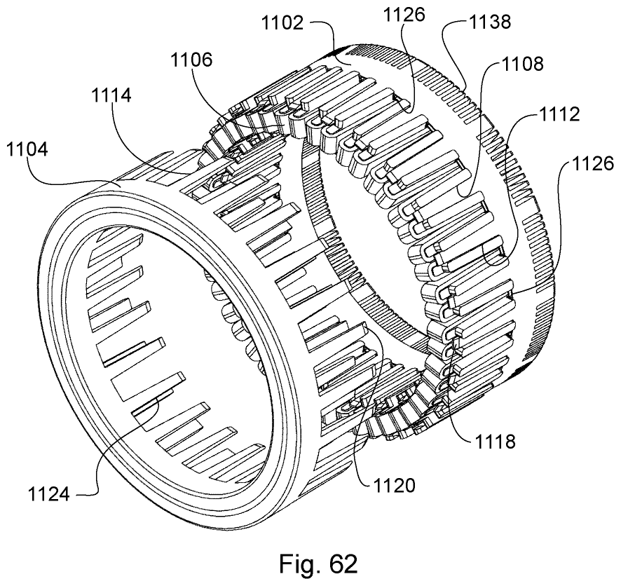

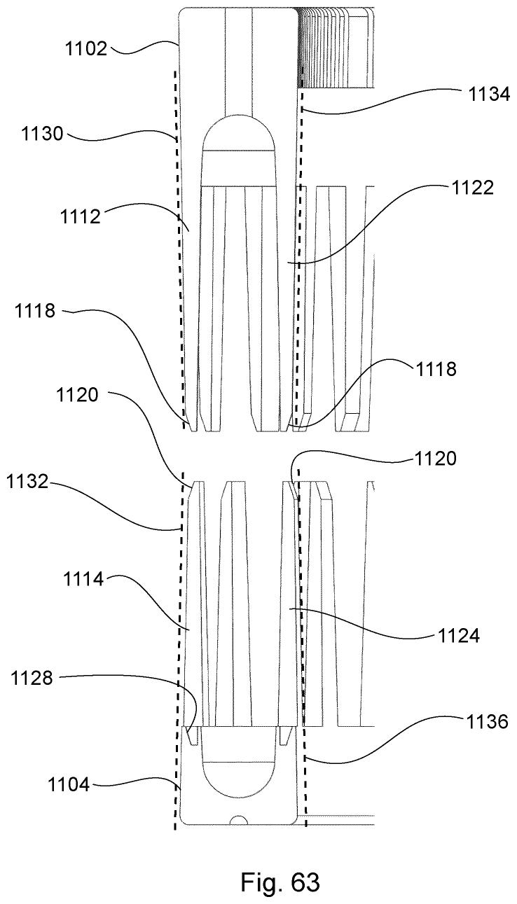

As shown in FIG. 62, as the tapered fingers slot together they may preload the posts 1108 holding them in place.

As shown in FIG. 63, the fingers 1112, 1114, 1122 and 1124 are also tapered as shown by representative dotted lines 1130, 1132, 1134 and 1136 which are drawn for clarity. The outer fingers 1112 and 1114 and the inner fingers 1122 and 1124 are each tapered so the fingers on the inner and outer rows are closer to each other as both inner and outer fingers extend away from the main bodies of the structural members 1102 and 1104. In other words, the lines 1130 and 1134 will eventually converge, and so will lines 1132 and 1136. The first and second structural members 1102, 1104 will resist any motions pulling them apart due to the friction fit created between the tapered interface surfaces and the posts.

The first sets of fingers 1112 and 1122 each have a tapered end 1118. The second sets of fingers 1114 and 1124 each have a tapered end 1120. Each tapered end 1118 and 1120 is wedged into corresponding respective recesses 1128 (FIG. 63) in the second structural member 1104 and 1126 (FIG. 26) in the first structural member 1102.

In different embodiments, a loose fit between the fingers is also possible and a potting compound, bolts, or other means may be used to secure the fingers together.

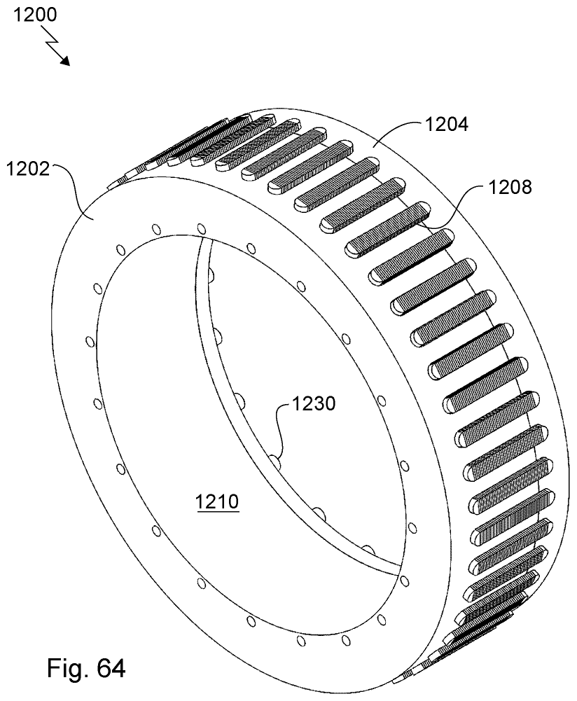

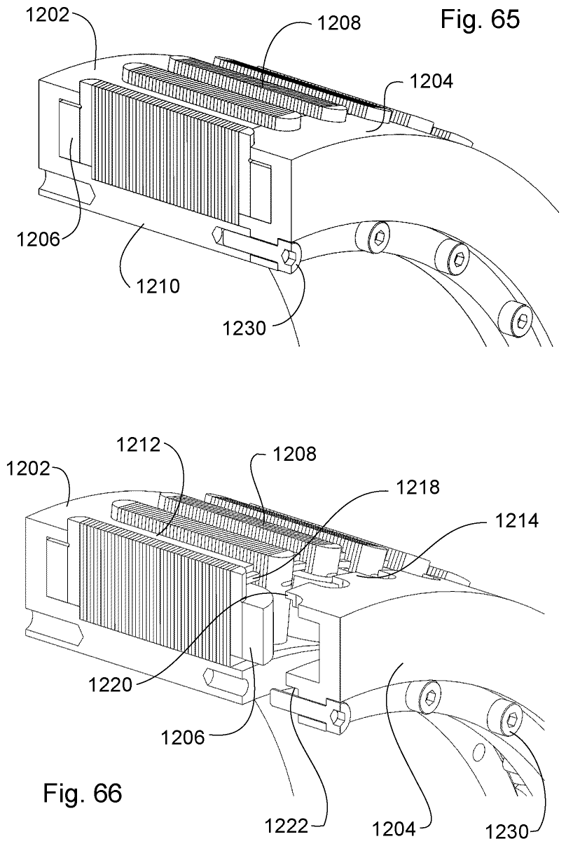

FIGS. 64 to 67 show a radial stator of a stator cage 1200 for a radial electric machine. There is a first structural member 1202 having an outer set of fingers 1212 and a backiron 1210 and a second structural member 1204 having an outer set of extending shoulders 1214 and inner shoulder 1222. The outer set of extending shoulders 1214 are placed adjacent to each of the outer set of fingers 1212 when the stator is assembled and the inner shoulder 1222 is placed adjacent to the backiron 1210. The first and second structural members 1202 and 1204 are secured together using bolts 1230 as shown in FIG. 65. A plurality of windings 1206 are connected around the plurality of posts 1208. The plurality of windings 1206 are connected around every second one of the plurality of posts 1208 and are encased within the cage 1200 defined by the first and second structural members 1202, 1204 and the plurality of posts 1208 as shown in FIG. 65. The cage 1200 defines an enclosure which may contain a potting agent. The plurality of posts 1208 are positioned between and extend beyond corresponding inner and outer slots. Tabs 1218 on the outer set of fingers 1212 cooperate with tabs 1220 on the outer set of shoulders 1214 to secure the stator in place which may assist in holding the first and second structural members in position relative to each other.

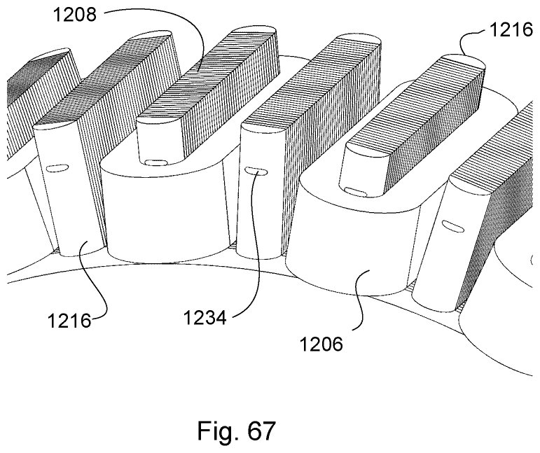

As shown in FIG. 67, the posts are laminated and have PEEK (or other suitable non-electrically-conductive) post caps 1216 glued on each end of the posts. The rounded surfaces of the post caps 1216 can reduce the potential damage to the windings and other components during installation and operation of the electric machine which might otherwise be caused by the sharp edges of the (eg: punch formed laminate) posts. Other suitable materials other than PEEK can be used. Grooves 1234 can be cut into the post caps which can receive a string or wire (not shown) that holds the coils in place prior to the assembly of the aluminum cage enclosure. Rounded post caps could be used in various of the embodiments described herein.

The interdigitated stators disclosed in various embodiments herein may be constructed using the following method: a first structural member comprising a first set of fingers is provided, a second structural member comprising a second set of fingers is provided. The first structural member is secured to the second structural member by interdigitating the first and second set of fingers. The first and second structural members define a plurality of slots between the interdigitated fingers. A plurality of posts is placed through the plurality of slots. The interdigitated fingers may be secured using an interference fit or using cooperating tabs and recesses on the first and second structural members or a combination of an interference fit and cooperating tabs and recesses or other means.

In order to facilitate cooling, the cages described herein may be constructed from a material with desirable heat conduction and dissipation properties. Various heat radiating features may be used, including, but not limited to “fins” which increase surface area. The stator may have cooling channels which facilitate the flow of ambient air or forced air or other suitable cooling fluid.

The stator posts described herein may have tabs such as tabs 220 as shown in FIG. 9 constructed from material such as stamped steel laminations constructed from stacks arranged with maximum length radially where the surface face of each layer of lamination is oriented tangentially from the diameter with the intent to decrease eddy currents.

For the radial embodiments, the depth of the posts may be in the axial direction. The centerline of each post may be radial. The width of the posts may extend axially and the radial length of posts may span the inner and outer diameter of the stator. The lamination direction of each post may be oriented radially. The posts may extend radially and which allows the posts to interface with the outside diameter of the stator.

The coils described herein may be constructed from material with high electrical conductivity and low resistance such but not limited to copper, aluminum or gold, and may be constructed from windings of wire. The wires may interface with the posts for added structure and to dissipate heat. The wires may feature an insulated surface to prevent electrical short circuits, such as being coated with an insulator. The surfaces of the posts and cage may also be coated with an insulating material to supplement or replace the insulation coating of the wire.

The posts described herein may have a variety of designs, including solid posts as part of one-piece stator, solid post inserts with no laminations, laminated inserts or staples which may be laminated or not.

The posts may be a solid ferromagnetic metal such as steel for example or formed using ferromagnetic powder.

After assembly, the posts and coils and structure may form one piece that is not adjustable.

Extending the posts beyond the aluminum cage structure defined by the first and second structural members may allow the use of aluminum for the structure by reducing the magnetic field that interacts with the aluminum and by moving the aluminum away from the airgap where the field of the rotor is strongest. This effect favors a very high pole count motor as well, because the magnetic field of the rotor becomes much shorter. This means the posts can protrude less without causing eddy currents in the aluminum which saves weight and reduces the flux leakage between the stator posts.

Use of aluminum may be beneficial because it is very light, low cost, a good heat conductor, has high heat capacity, is strong, reasonably stiff (aluminum composite materials such as Primex™ can be very stiff), easily machined and can be inexpensively hard anodized for toughness and for uniform and precise electrical insulation as well as to create attractive colors.

Although aluminum cannot typically be used in motors as a structure around the posts or near the airgap because of eddy currents, the embodiment disclosed herein make it possible to use aluminum or similar materials (such as metal matrix composites) with the above benefits without developing high eddy currents.

The interdigitated stator structure eliminates the eddy current path around stator posts and creates eddy current breaks. In other embodiments, non-interdigitated stators are also designed with eddy current breaks. The posts can extend past the ID and/or OD of the aluminum structure to get the aluminum away from the airgap. High pole density may be beneficial by reducing the necessary length of the posts beyond the aluminum.

Embodiments disclosed herein may allow for low cost manufacturing since an aluminum stator cage can be cast or metal injection molded etc., laminated inserts or powdered metal can be stamped or otherwise formed. Winding every second post allows for half of the number of coils.

Embodiments disclosed herein may allow for high performance as a result of light weight (high torque to weight), effective use of materials with a two-sided stator, and shorter axial length of motor possible for the same torque due to having a double stator.

Encapsulation of coils in an aluminum cage may protect the magnets from overheating and may allow higher internal temperatures without requiring a potting compound to hold the coils in place because the aluminum cage does that.

Having encapsulated coils may allow routing air or liquid though the sealed casing for additional cooling.

The stator may include posts that are angled in alternating directions to be used with tapered fingers.

Although the foregoing description has been made with respect to preferred embodiments of the present invention it will be understood by those skilled in the art that many variations and alterations are possible. Some of these variations have been discussed above and others will be apparent to those skilled in the art.

In the claims, the word “comprising” is used in its inclusive sense and does not exclude the possibility of other elements being present. The indefinite article “a/an” before a claim feature does not exclude more than one of the feature being present unless it is clear from the context that only a single element is intended.

1. A stator for an electric machine comprising:
a first structural member having a first set of fingers;
a second structural member having a second set of fingers interdigitating with the first set of fingers and defining a plurality of slots between the interdigitated fingers; and
a plurality of posts positioned in the plurality of slots.

2. (canceled)

3. (canceled)

4. The stator of claim 5 in which the electric machine is a radial electric machine.

5. The stator of claim 1 in which:
the first set of fingers further comprises a first inner set of fingers and a first outer set of fingers;
the second set of fingers further comprises a second inner set of fingers and second outer set of fingers;
the first and second inner sets of fingers are interdigitated and define a plurality of inner slots between them; and
the first and second outer sets of fingers are interdigitated and define a plurality of outer slots between the interdigitated inner fingers.

6. The stator of claim 5 in which each of the plurality of posts are positioned between corresponding inner and outer slots of the plurality of inner and outer slots.

7. The stator of claim 6 in which the first and second structural members and the plurality of posts together form a cage defining an enclosure.

8. (canceled)

9. The stator of claim 5 further comprising:
a first inner tapered surface on each finger of the first inner set of fingers;
a second inner tapered surface on each finger of the second inner set of fingers corresponding to one of the first inner tapered surfaces; and
in which corresponding first and second inner tapered surfaces are in contact.

10. (canceled)

11. The stator of claim 5 further comprising:
a first outer tapered surface on each finger of the first outer set of fingers;
a second outer tapered surface on each finger of the second outer set of fingers corresponding to one of the first outer tapered surfaces; and
in which corresponding first and second outer tapered surfaces are in contact.

12. (canceled)

13. The stator of claim 5 in which the first structural member further comprises a plurality of cooling fins.

14. The stator of claim 5 in which the first and second structural members comprise a plurality of retaining tabs and a plurality of recesses, and in which the plurality of retaining tabs and plurality of recesses cooperate to secure the first and second structural members in place.

15. The stator of claim 5 in which each of the plurality of posts are positioned between and extend beyond corresponding inner and outer slots of the plurality of inner and outer slots.

16. (canceled)

17. (canceled)

18. The stator of claim 19 in which the electric machine is a linear electric machine.

19. The stator of claim 1 in which:
the first set of fingers further comprises two first rows of fingers;
the second set of fingers further comprises two second rows of fingers;
the two first rows of fingers and two second rows of fingers are interdigitated and define two rows of slots.

20. The stator of claim 19 in which each of the plurality of posts are positioned between the two rows of slots.

21. The stator of claim 20 in which each of the plurality of posts extend beyond the two rows of slots.

22. The stator of claim 20 in which the first and second structural members and the plurality of posts together form a cage defining an enclosure.

23. (canceled)

24. The stator of claim 19 further comprising first tapered contact surfaces on each of the first two rows of fingers and second tapered contact surfaces on each of the second two rows of fingers corresponding to the first tapered contact surfaces, and in which the corresponding first and second tapered contact surfaces are in contact.

25. (canceled)

26. The stator of claim 19 in which the first and second structural members comprise a plurality of retaining tabs and a plurality of recesses, and in which the plurality of retaining tabs and plurality of recesses cooperate to secure the first and second structural members in place.

27. The stator of claim 28 in which the electric machine is an axial electric machine having an axis.

28. The stator of claim 1 in which the stator further comprises:
a first tapered surface on each of the first sets of fingers; and
a second tapered surface on each of the second sets of fingers.

29. The stator of claim 1 further comprising:
a plurality of first retaining tabs, one of the plurality of first retaining tabs on each of the first set of fingers; and
a plurality of first recesses on the second structural member, each of the plurality of first recesses corresponding to each of the first retaining tabs.

30-36. (canceled)

37. A stator for an electric machine, comprising:
a cage defining an enclosure, the cage comprising a first structural member and a second structural member, the cage comprising eddy current breaks;
the first and second structural members defining a plurality of slots; and
a plurality of posts positioned in the plurality of slots.

38. (canceled)

39. (canceled)

40. The stator of claim 37 in which:
the first structural member comprises a first plurality of slots;
the second structural member comprises a second plurality of slots; and
each of the plurality of posts are inserted into one of the first plurality of slots and a corresponding one of the second plurality of slots.

41. The stator of claim 40 in which the electric machine is an axial electric machine and in which:
the first structural member comprises a first disk, the first plurality of slots being arranged radially around the first disk; and
the second structural member comprises a second disk, the second plurality of slots being arranged radially around the second disk.

42. The stator of claim 40 in which the electric machine is a linear electric machine and in which:
the first structural member comprises a first plate, the first plurality of slots being arranged in a row along the first plate;
the second structural member comprises a second plate, the second plurality of slots being arranged in a row along the second plate.

43. The stator of claim 40 in which the electric machine is a radial electric machine and in which:
the first structural member comprises a first cylindrical surface, the first plurality of slots being arranged circumferentially around the first cylindrical surface; and
the second structural member comprises a second cylindrical surface, second plurality of slots being arranged circumferentially around the second cylindrical surface.

44. The stator of claim 37 in which:
the first structural member further comprises a first set of fingers;
the second structural member further comprises a second set of fingers interdigitating with the first set of fingers; and
the interdigitated first and second set of fingers form the eddy current breaks.

45-64. (canceled)
